(19) United States
(12) Patent Application Publication
(10) Pub. No.: US 2026/0143443 A1
(43) Pub. Date: May 21, 2026

(54) ANTENNA DEVICE AND CONTROL METHOD

(71) Applicant: KABUSHIKI KAISHA TOSHIBA, Kawasaki-shi, Kanagawa (JP)

(72) Inventor: Hiroki MORI, Kawasaki Kanagawa (JP)

(73) Assignee: KABUSHIKI KAISHA TOSHIBA, Kawasaki-shi, Kanagawa (JP)

(21) Appl. No.: 19/314,137

(22) Filed: Aug. 29, 2025

(30) Foreign Application Priority Data
Nov. 20, 2024 (JP) 2024-202322

(51) Int. Cl. H04W 56/00; H04L 5/00

(52) U.S. Cl. CPC H04W 56/0035; H04L 5/0048; H04W 56/004

(57) ABSTRACT

According to one embodiment, an antenna device includes a first module including first transmit and receive antennas and a second module including second transmit and receive antennas. The first transmit antennas transmit radio waves based on a first reference signal. The second transmit antennas transmit radio waves based on a second reference signal. A phase value is calculated based on a phase difference between received signals of two virtual antennas formed based on received signals of the first receive antennas. A phase of the second reference signal is shifted by the phase value.

### CROSS-REFERENCE TO RELATED APPLICATIONS

This application is based upon and claims the benefit of priority from Japanese Patent Application No. 2024-202322, filed Nov. 20, 2024, the entire contents of which are incorporated herein by reference.

### BACKGROUND

Embodiments described herein relate generally to an antenna device and a control method.

In an antenna device that estimates a direction of a target, it is required to improve a spatial resolution. In recent years, instead of actually increasing the number of antennas to improve a spatial resolution, a multi input multi output (MIMO) array antenna has been developed. The MIMO array antenna virtually forms many antennas through signal processing.

However, in a case where a virtual array antenna is further extended, the disposition and wiring of an antenna on a substrate become complicated. Therefore, the power supply loss and the development cost increase. In addition, there is a demand for a technique of adjusting conflicting functions such as a function of improving a spatial resolution of a virtual array antenna and a function of improving the accuracy of estimating a direction of a target in a virtual array antenna according to a purpose of an antenna device.

### BRIEF DESCRIPTION OF THE DRAWINGS

FIG. 1 is a diagram illustrating a configuration example of a first module used in an antenna device according to a first comparative example.

FIG. 2 is a diagram illustrating a configuration example of an antenna device according to a first embodiment.

FIG. 3 is a diagram illustrating a transmission timing of each transmit antenna and a reception timing of each receive antenna in a second comparative example.

FIG. 4 is a diagram illustrating an example of a virtual array antenna formed by an antenna device according to the second comparative example.

FIG. 5 is a diagram illustrating a transmission timing of each transmit antenna and a reception timing of each receive antenna in the first embodiment.

FIG. 6 is a diagram illustrating an example of a virtual array antenna formed by the antenna device according to the first embodiment.

FIG. 7 is a block diagram illustrating an electrical configuration example of the antenna device according to the second comparative example.

FIG. 8 is a block diagram illustrating an electrical configuration example of the antenna device according to the first embodiment.

FIG. 9 is a graph illustrating a simulation result of target direction estimation of the antenna device according to the first embodiment.

FIG. 10 is a diagram illustrating a first configuration example of a first module and a second module in the first embodiment.

FIG. 11 is a diagram illustrating a second configuration example of the first module and the second module in the first embodiment.

FIG. 12 is a diagram illustrating a third configuration example of the first module and the second module in the first embodiment.

FIG. 13 is a diagram illustrating a fourth configuration example of the first module and the second module in the first embodiment.

FIG. 14 is a diagram illustrating an example of a virtual array antenna in a first modification example.

FIG. 15 is a diagram illustrating a configuration example of an antenna device according to a second embodiment.

FIG. 16 is a diagram illustrating an example of a virtual antenna formed by an antenna device according to a third comparative example.

FIG. 17 is a diagram illustrating an example of a virtual array antenna formed by the antenna device according to the second embodiment.

FIG. 18 is a block diagram illustrating an electrical configuration example of the antenna device according to the second embodiment.

FIG. 19 is a block diagram illustrating an electrical configuration of an antenna device according to a second modification example.

FIG. 20 is a block diagram illustrating an electrical configuration example of an antenna device according to a third embodiment.

FIG. 21 is a block diagram illustrating an electrical configuration example of an antenna device according to a third modification example.

FIG. 22 is a block diagram illustrating an electrical configuration example of an antenna device according to a fourth modification example.

FIG. 23 is a diagram illustrating an application example of the antenna device according to the present embodiment.

### DETAILED DESCRIPTION

Hereinafter, embodiments will be described with reference to the drawings. The following description exemplifies a device and a control method for embodying the technical idea of the embodiment, and the technical idea of the embodiment is not limited to structures, shapes, a disposition, materials, and the like of the constituents described below. Modifications easily conceivable by those skilled in the art are naturally included in the scope of the disclosure. In order to make the description clearer, in the drawings, a size, a thickness, a planar dimension, a shape, or the like of each element may be schematically represented by changing the size, the thickness, the planar dimension, the shape, or the like with respect to the actual embodiment. In a plurality of drawings, elements having different dimensional relationships and ratios may be included. In a plurality of drawings, corresponding elements are denoted by the same reference numerals, and redundant description may be omitted. Although some elements may be given a plurality of names, examples of these names are merely examples, and it is not negated that these elements may be given other names. In addition, it is not denied that other names are given to elements to which a plurality of names are not given. In the following description, “connection” includes not only direct connection but also connection via another element.

In general, according to one embodiment, an antenna device comprising a reference signal generator, a first module to which a first reference signal is supplied from the reference signal generator, a second module to which a second reference signal is supplied from the reference signal generator, and a phase value generator, wherein, the first module comprises a first number of first transmit antennas arranged in a first direction at a first interval, and a second number of first receive antennas arranged in the first direction at a second interval, the second module comprises a third number of second transmit antennas arranged in the first direction at the first interval, a fourth number of second receive antennas arranged in the first direction at the second interval, and a first transmission processor, an interval between a receive antenna closest to the second module among the first receive antennas and a receive antenna closest to the first module among the second receive antennas corresponds to the second interval, the phase value generator is configured to generate a first phase value based on a phase difference between received signals of at least two virtual antennas among a plurality of virtual antennas formed based on received signals of at least some of the first receive antennas and the second receive antennas when the first transmit antennas transmit radio waves based on the first reference signal, the first transmission processor is configured to shift a phase of the second reference signal supplied to the second transmit antennas subsequent to the first transmit antennas by the first phase value.

### First Embodiment

First, a first embodiment will be described. An antenna device according to the first embodiment is used to transmit a radio wave to a target, receive the radio wave reflected at the target, and estimate a direction of the target. An example of the radio wave as a radar signal used in the first embodiment is a radio wave having a wavelength of 1 mm to 30 mm. The radio wave having a wavelength of 1 mm to 10 mm is also referred to as a millimeter wave. A radio wave having a wavelength of 10 mm to 100 mm is also referred to as a microwave. Another example of the radio wave is a radio wave called a terahertz wave having a wavelength of 100 micrometers to 1 millimeter.

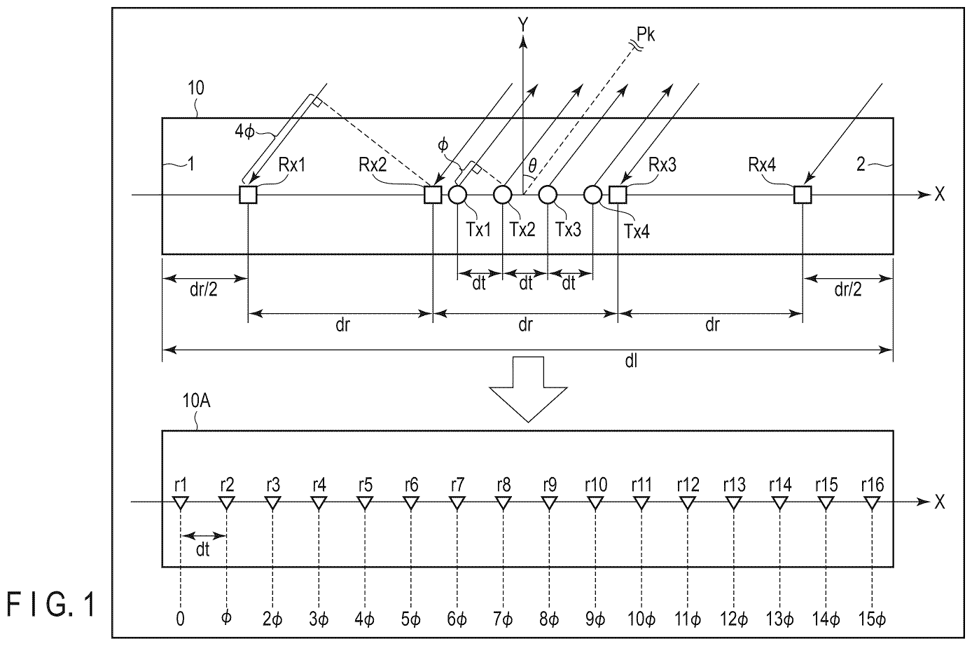

FIG. 1 illustrates a configuration example of a first module 10 used in an antenna device according to a first comparative example.

The first module 10 in the first comparative example includes at least one IC, N1 (first number) transmit antennas Tx1, Tx2, Tx3, and Tx4, and M1 (second number) receive antennas Rx1, Rx2, Rx3, and Rx4. In the example in FIG. 1, both N1 and M1 are positive integers. In FIG. 1, both N1 and M1 are four. The transmit antennas Tx1, Tx2, Tx3, and Tx4 and the receive antennas Rx1, Rx2, Rx3, and Rx4 are connected to an IC on one substrate.

The transmit antennas Tx1, Tx2, Tx3, and Tx4 are arranged in a first direction at a first interval dt to configure a linear array antenna. Hereinafter, the transmit antennas Tx1, Tx2, Tx3, and Tx4 may be collectively referred to as a transmit array antenna. The first interval dt is a substantially half wavelength d (=λ/2) of a wavelength having the highest intensity included in an radio wave transmitted from the transmit antennas Tx1, Tx2, Tx3, and Tx4 and an radio wave received by the receive antennas Rx1, Rx2, Rx3, and Rx4. The first direction is a direction along the X-axis. The substantially half wavelength is a wavelength included within ±30%, preferably within ±20%, and more preferably within ±10% of the half wavelength.

The receive antennas Rx1, Rx2, Rx3, and Rx4 are arranged in the first direction at a second interval dr to configure a linear array antenna. Hereinafter, the receive antennas Rx1, Rx2, Rx3, and Rx4 may be collectively referred to as a receive array antenna. The second interval dr is several times the substantially half wavelength d, the several times being the number of receive antennas. In other words, the second interval dr is N1×dt. In the example in FIG. 1, a distance from a left end 1 of the first module 10 to the receive antenna Rx1 closest to the left end 1 is half the second interval dr (=dr/2). Similarly, a distance from a right end 2 of the first module 10 to the receive antenna Rx4 closest to the right end 2 is half the second interval dr. That is, a length d1 of the first module 10 in the X-axis direction is the second interval dr×M1 (M1 is the number of receive antennas).

In the example in FIG. 1, the transmit antennas Tx1, Tx2, Tx3, and Tx4 are disposed between the receive antenna Rx2 and the receive antenna R3. In addition, the transmit antennas Tx1, Tx2, Tx3, and Tx4 and the receive antennas Rx1, Rx2, Rx3, and Rx4 are arranged on the same straight line, and a position of the center of the transmit array antenna and a position of the center of the receive array antenna are substantially the same.

Note that, since the transmit antenna and the receive antenna are compatible, in the following description, the transmit antenna may be referred to as a receive antenna, and the receive antenna may be referred to as a transmit antenna.

Here, according to the method of forming a MIMO array antenna, sixteen virtual antennas (MIMO antennas) r1 to r16 illustrated in the lower part of FIG. 1 are formed from the transmit antennas Tx1, Tx2, Tx3, and Tx4 and the receive antennas Rx1, Rx2, Rx3, and Rx4. In other words, when the transmit array antenna including N1 transmit antennas and the receive array antenna including M1 receive antennas are used, the virtual array antenna (MIMO array antenna) including N1×M1 virtual antennas can be formed.

Specifically, the transmit antennas Tx1, Tx2, Tx3, and Tx4 transmit radio waves corresponding to transmission signals of the transmit antennas Tx1, Tx2, Tx3, and Tx4 at a constant viewing angle. The transmit antennas Tx1, Tx2, Tx3, and Tx4 are time-divisionally driven, and are controlled to transmit radio waves corresponding to transmission signals of the transmit antennas Tx1, Tx2, Tx3, and Tx4 at different timings. The radio wave transmitted from the transmit antenna Tx1 is received by each of the receive antennas Rx1, Rx2, Rx3, and Rx4. The radio wave transmitted from the transmit antenna Tx2 is received by each of the receive antennas Rx1, Rx2, Rx3, and Rx4. The radio wave transmitted from the transmit antenna Tx3 is received by each of the receive antennas Rx1, Rx2, Rx3, and Rx4. The radio wave transmitted from the transmit antenna Tx4 is received by each of the receive antennas Rx1, Rx2, Rx3, and Rx4.

Here, a received signal output from the receive antenna Rx1 in a situation in which a k-th target Pk exists on the extension of an angle θ from the antenna device will be considered. A radio wave transmitted from the transmit antenna Tx1 is reflected by the target Pk. The reflected wave is received by the receive antenna Rx1. A radio wave transmitted from the transmit antenna Tx2 is reflected by the target Pk. The reflected wave is received by the receive antenna Rx1. A propagation path of the radio wave transmitted from the transmit antenna Tx1 and received by the receive antenna Rx1, and a propagation path of the radio wave transmitted from the transmit antenna Tx2 and received by the receive antenna Rx1 have a difference (path difference). The difference is according to the interval (first interval dt) between the transmit antenna Tx1 and the transmit antenna Tx2. The difference causes a phase difference between the two received signals. Hereinafter, a phase difference caused by the difference between the propagation paths is denoted by φ.

In addition, A radio wave transmitted from the transmit antenna Tx1 is reflected by the target Pk. The reflected wave is received by the receive antenna Rx1. A radio wave transmitted from the transmit antenna Tx3 is reflected by the target Pk. The reflected wave is received by the receive antenna Rx1. A propagation path of the radio wave transmitted from the transmit antenna Tx1 and received by the receive antenna Rx1, and a propagation path of the radio wave transmitted from the transmit antenna Tx3 and received by the receive antenna Rx1 have a difference. The difference is according to the interval (first interval dt×2) between the transmit antenna Tx1 and the transmit antenna Tx3. This difference causes a phase difference 2φ between the two received signals. Similarly, A radio wave transmitted from the transmit antenna Tx1 is reflected by the target Pk. The reflected wave is received by the receive antenna Rx1. A radio wave transmitted from the transmit antenna Tx4 is reflected by the target Pk. The reflected wave is received by the receive antenna Rx1. A propagation path of the radio wave transmitted from the transmit antenna Tx1 and received by the receive antenna Rx1, and a propagation path of the radio wave transmitted from the transmit antenna Tx4 and received by the receive antenna Rx1 have a difference. The difference is according to the interval (first interval dt×3) between the transmit antenna Tx1 and the transmit antenna Tx4. That is, a phase difference 3φ is generated between the two received signals.

As described above, the receive antenna Rx1 outputs four received signals due to the radio waves transmitted from the transmit antennas Tx1, Tx2, Tx3, and Tx4. If the phase of the received signal based on the radio wave reflected at the target Pk is a reference, the phase differences of the four received signals are 0, φ, 2φ, and 3φ, respectively. The four received signals output from the receive antenna Rx1 correspond to four received signals output from four receive antennas arranged with the first interval dt.

That is, by transmitting radio waves in a time division manner from the transmit antennas Tx1, Tx2, Tx3, and Tx4, four virtual antennas r1, r2, r3, and r4 disposed in the X-axis direction at the first interval dt can be formed based on the received signals output from the receive antenna Rx1. In addition, the phase difference φ can be referred to as a phase difference between received signals in two adjacent virtual antennas among the four virtual antennas r1, r2, r3, and r4.

Next, in a similar situation, a phase difference between the received signal output from the receive antenna Rx1 and the received signal output from the receive antenna Rx2 will be considered. A radio wave transmitted from the transmit antenna Tx1 is reflected by the target Pk. The reflected radio wave is received by the receive antenna Rx1 and the receive antenna Rx2. A propagation path of the radio wave transmitted from the transmit antenna Tx1, reflected at the target Pk, and received by the receive antenna Rx2, and a propagation path of the radio wave transmitted from the transmit antenna Tx1, reflected at the target Pk, and received by the receive antenna Rx1 have a difference. The difference is according to the interval (first interval dt×4) between the receive antenna Rx1 and the receive antenna Rx2. That is, a phase difference 4φ is generated between the two received signals.

Similarly, a radio wave transmitted from the transmit antenna Tx2 is reflected by the target Pk. The reflected radio wave is received by the receive antenna Rx1 and the receive antenna Rx2. A propagation path of the radio wave transmitted from the transmit antenna Tx2, and reflected at the target Pk, and received by the receive antenna Rx2, and a propagation path of the radio wave transmitted from the transmit antenna Tx2, reflected at the target Pk, and received by the receive antenna Rx1 have a difference. The difference according to the interval (first interval dt×4) between the receive antenna Rx1 and the receive antenna Rx2. Similarly, radio waves transmitted from the transmit antenna Tx3 and Tx4 are reflected by the target Pk. The reflected radio waves are received by the receive antenna Rx1 and the receive antenna Rx2. Propagation paths of the radio waves transmitted from the transmit antenna Tx3 and Tx4, reflected at the target Pk, and received by the receive antenna Rx2, and propagation paths of the radio waves transmitted from the transmit antenna Tx3 and Tx4, reflected at the target Pk, and received by the receive antenna Rx1 have differences. The differences is according to the interval (first interval dt×4) between the receive antenna Rx1 and the receive antenna Rx2.

As described above, the receive antenna Rx2 can obtain the four received signals by the radio waves time-divisionally transmitted by the transmit antennas Tx1, Tx2, Tx3, and Tx4 being reflected at the target Pk. A phase difference between each received signal output from the receive antenna Rx2 and each received signal output from the receive antenna Rx1 is 40. That is, in a case where the phase of the received signal output from the receive antenna Rx1 by the radio wave transmitted by the transmit antenna Tx1 being reflected at the target Pk is used as a reference, the phase differences of the received signals output from the receive antenna Rx2 are 4φ, 5φ, 6φ, and 7φ obtained by adding 4φ to the phase differences 0, φ, 2φ, and 3φ of the received signals received by the receive antenna Rx1, respectively. The four received signals output form the receive antenna Rx2 correspond to four received signals output from four receive antennas arranged with the first interval dt.

That is, the four virtual antennas r5, r6, r7, and r8 disposed in the X-axis direction at the first interval dt can be formed based on the received signals output from the receive antenna Rx2 by the radio waves being transmitted in a time division manner from the transmit antennas Tx1, Tx2, Tx3, and Tx4.

Similarly, for the receive antennas Rx3 and Rx4, the four virtual antennas r9, r10, r11, and r12 disposed in the X-axis direction at the first interval dt are formed based on the received signals output from the receive antenna Rx3. The four virtual antennas r13, r14, r15, and r16 disposed in the X-axis direction at the first interval dt are formed based on the received signals output from the receive antenna Rx4. That is, according to the transmit antennas Tx1, Tx2, Tx3, and Tx4 and the receive antennas Rx1, Rx2, Rx3, and Rx4 illustrated in FIG. 1, the 16 virtual antennas r1 to r16 with no overlap can be formed.

Here, according to the transmit antennas Tx1, Tx2, Tx3, and Tx4 and the receive antennas Rx1, Rx2, Rx3, and Rx4 illustrated in FIG. 1, forming 16 virtual antennas with no overlap will be described by using an equation. Here, in order to simplify the description, the center between the transmit antenna Tx2 and the transmit antenna Tx3 is set as the origin. The center position between the transmit antenna Tx2 and the transmit antenna Tx3 is the same as the center position between the receive antenna Rx2 and the receive antenna Rx3. In addition, as illustrated in FIG. 1, a situation is assumed in which the k-th target Pk exists on the extension of the angle θ from the antenna device.

In this case, reception data x(t) at a certain time t is modeled as in Equation 1.

$$x ( t ) = As ( t ) + n ( t ) = {\sum }_{k = {1}^{{a}_{r}}}^{k} ( {θ}_{k} ) ⊗ {a}_{t} ( {θ}_{k} ) {s}_{k} + n ( t ) \qquad Equation l$$

⊗ is the Kronecker product.
Here, A is a mode matrix,
s(t) is a complex amplitude vector of a received signal at the time t,
n(t) is a noise vector at the time t, Ok is an arrival direction of a radio wave from the k-th target Pk,
aₜ(θₖ) is a mode vector of a transmit array antenna for any k, and
aᵣ(θₖ) is a mode vector of a receive array antenna for any k.

Here, aₜ(θₖ) and aᵣ(θₖ) can be defined as Equations 2 and 3 with the midpoint between the transmit antenna Tx2 and the transmit antenna Tx3 in FIG. 1 as a reference.

$${a}_{t} ( {θ}_{k} ) = {[ {e}^{- 3 ω} , {e}^{- 1 ω} , {e}^{1 ω} , {e}^{3 ω} ]}^{T} \qquad Equation 2$$

$${a}_{r} ( {θ}_{k} ) = {[ {e}^{- 12 ω} , {e}^{- 4 ω} , {e}^{4 ω} {e}^{12 ω} ]}^{T} \qquad Equation 3$$

$$Here , ω = \frac{- 2 Π d sin θ k}{λ} .$$

When a Kronecker product of aₜ(θₖ) and aᵣ(θₖ) is set as a mode vector aᵥ(θₖ) of the virtual array antenna for any k, the Kronecker product aᵥ(θₖ) can be expressed as in the following Equation 4.

$${a}_{v} ( θ k ) = {a}_{r} ( θ k ) ⊗ {a}_{t} ( θ k ) = \begin{matrix}[ {e}^{- 15 ω} , {e}^{- 13 ω} , {e}^{- 11 ω} , {e}^{- 9 ω} , {e}^{- 7 ω} , {e}^{- 5 ω} , {e}^{- 3 ω} , {e}^{- ω} , \\ {{e}^{ω} , {e}^{3 w} , {e}^{5 w} , {e}^{7 w} , {e}^{9 w} , {e}^{11 w} , {e}^{13 w} , {e}^{15 w} ]}^{T}\end{matrix} \qquad Equation 4$$

According to Equation 4, since sixteen phase states are included, it can be seen that the virtual array antenna in which sixteen antennas are arranged in the X-axis direction at the first interval dt is formed based on the four transmit antennas and the four receive antennas. As can be seen from Equation 4, there is no overlapping component in the mode vector aᵥ(θₖ) of the virtual array antenna. That is, it can be seen from Equation 4 that the transmit antennas Tx1, Tx2, Tx3, and Tx4 and the receive antennas Rx1, Rx2, Rx3, and Rx4 are disposed as illustrated in the upper part of FIG. 1, so that the sixteen virtual antennas r1 to r16 (virtual array antenna 10A) with no overlap can be formed.

In order to further improve the spatial resolution of the virtual array antenna 10A, the number of antennas may be increased. However, the number of antennas connectable to the same IC is limited. For example, a method of increasing the number of antennas by cascade-connecting a plurality of ICs on the same substrate is conceivable. By supplying a common reference signal (local signal) to a plurality of ICs connected in cascade, it is possible to maintain coherency and realize a spatial resolution according to the number of antennas. However, in general, it is necessary to wire an IC to a transmit antenna and a receive antenna with equal lengths. Therefore, in a case where the number of antennas is increased so that virtual antennas do not overlap, wiring from a plurality of ICs on the same substrate to a plurality of corresponding transmit antennas and a plurality of corresponding receive antennas becomes complicated. In addition, it is necessary to extend or detour a power feed line, and thus there is a possibility that the radiation loss increases.

Therefore, in the present embodiment, it is considered to increase the aperture length of the antenna device by coupling two modules in which the receive antenna and the transmit antenna are already arranged. Examples of the modules include the first module 10 of the antenna device according to the first comparative example. In the following description, the term “coupling” indicates that a plurality of modules are arranged on the same straight line and controlled in conjunction with each other.

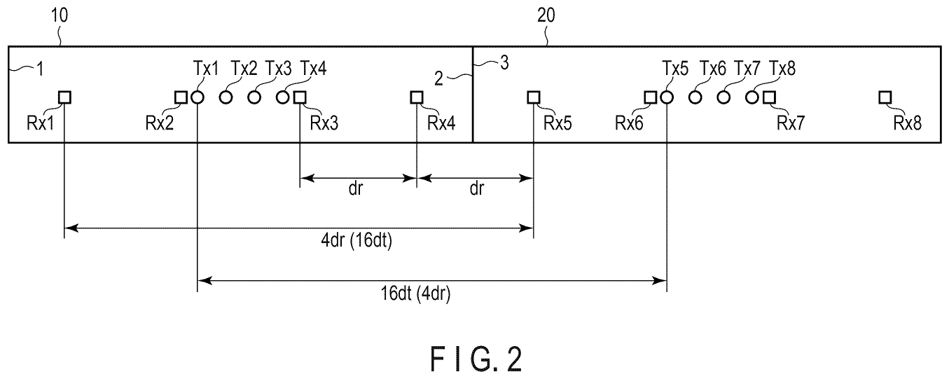

FIG. 2 is a diagram illustrating a configuration example of the antenna device according to the present embodiment. The antenna device according to the present embodiment includes a second module 20 in addition to the first module 10 described with reference to FIG. 1.

The second module 20 includes at least one IC, N2 (third number) transmit antennas Tx5, Tx6, Tx7, and Tx8, and M2 (fourth number) receive antennas Rx5, Rx6, Rx7, and Rx8. Each of the transmit antennas Tx5, Tx6, Tx7, and Tx8 is connected to the IC. Each of the receive antennas Rx5, Rx6, Rx7, and Rx8 is connected to the IC. In the example in FIG. 2, both N2 and M2 are positive integers, and are four. The disposition of the transmit antennas Tx5, Tx6, Tx7, and Tx8 is the same as that of the transmit antennas Tx1, Tx2, Tx3, and Tx4. The disposition of the receive antennas Rx5, Rx6, Rx7, and Rx8 is the same as the disposition of the receive antennas Rx1, Rx2, Rx3, and Rx4. Note that the first module 10 and the second module 20 may be configured on different substrates, or may be disposed on the same substrate.

The first module 10 and the second module 20 are disposed on a straight line in the X-axis direction. The receive antenna Rx4 is the closest to the second module 20 among the receive antennas Rx1, Rx2, Rx3 and Rx4 of the first module 10. The receive antenna Rx5 is the closest to the first module 10 among the receive antennas Rx5, Rx6, Rx7, and Rx8 of the second module 20. In this case, the first module 10 and the second module 20 are disposed such that an interval between the receive antenna Rx4 and the receive antenna Rx5 is the second interval dr. In the example illustrated in FIG. 2, the distance from the receive antenna Rx4 closest to the right end 2 of the first module 10 to the right end 2 is half the second interval dr (=dr/2). Similarly, the distance from the receive antenna Rx5 closest to the left end 3 of the second module 20 to the left end 3 is half the second interval dr (=dr/2). Thus, by adjoining the first module 10 and the second module 20 without a gap, the interval between the receive antenna Rx4 and the receive antenna Rx5 can be set to the second interval dr.

The distance between the transmit antenna Tx1 and the transmit antenna Tx5 is, for example, an integer multiple of the first interval dt. Hereinafter, the distance is assumed to be 16dt (4dr).

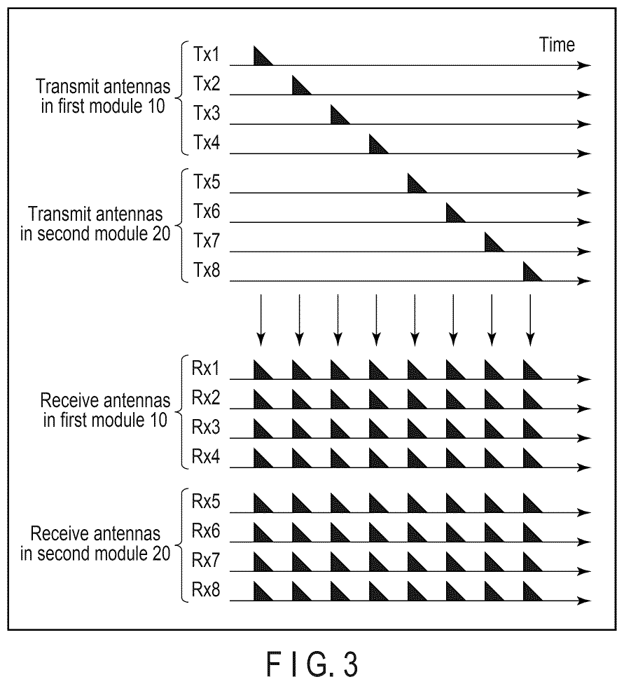

FIG. 3 is a diagram illustrating transmission timings of the transmit antennas Tx1 to Tx8 and reception timings of the receive antennas Rx1 to Rx8 in a second comparative example of the first embodiment. A lateral arrow in FIG. 3 indicates a time direction.

As illustrated in FIG. 3, when the transmit antenna Tx1 of the first module 10 transmits a radio wave, all the receive antennas Rx1 to Rx8 of the first module 10 and the second module 20 receive the radio wave (received signal) reflected at the target. Next, when the transmit antenna Tx2 of the first module 10 transmits a radio wave, all the receive antennas Rx1 to Rx8 of the first module 10 and the second module 20 receive the radio wave reflected at the target.

Thereafter, in a similar manner, when the transmit antennas Tx3 and Tx4 of the first module 10 transmit radio waves, all the receive antennas Rx1 to Rx8 of the first module 10 and the second module 20 receive the radio waves reflected at the target.

Subsequently, when the transmit antenna Tx5 of the second module 20 transmits a radio wave, all the receive antennas Rx1 to Rx8 of the first module 10 and the second module 20 receive the radio wave (received signal) reflected at the target. Thereafter, in a similar manner, every time the transmit antennas Tx6, Tx7, and Tx8 of the second module 20 transmit radio waves, all the receive antennas Rx1 to Rx8 of the first module 10 and the second module 20 receive the radio waves reflected at the target.

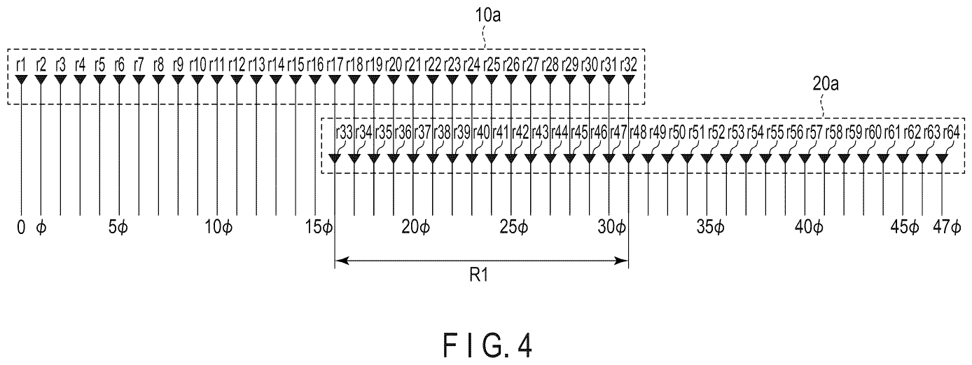

FIG. 4 is a diagram illustrating an example of a virtual array antenna formed by an antenna device according to the second comparative example of the first embodiment. 0, φ, . . . , 47φ in FIG. 4 indicate phase differences.

The virtual array antenna includes a first virtual array antenna 10a and a second virtual array antenna 20a-1. For convenience of description, the first virtual array antenna 10a and the second virtual array antenna 20a are shifted in the vertical direction in FIG. 4, but actually, the first virtual array antenna 10a and the second virtual array antenna 20a are formed to be aligned on the same straight line.

The first virtual array antenna 10a includes virtual antennas r1 to r32 arranged on a straight line in the X-axis direction at a second interval dr. The first virtual array antenna 10a is formed based on received signals output from the receive antennas Rx1 to Rx8 of the first module 10 and the second module 20 when radio waves are transmitted from the transmit antennas Tx1 to Tx4 of the first module 10 and received by the receive antennas Rx1 to Rx8 of the first module 10 and the second module 20.

The second virtual array antenna 20a includes virtual antennas r33 to r64 disposed on a straight line in the X-axis direction at the second interval dr. The second virtual array antenna 20a is formed based on received signals output from the receive antennas Rx1 to Rx8 of the first module 10 and the second module 20 when radio waves transmitted from the transmit antennas Tx5 to Tx8 of the second module 20.

Here, in a case where eight transmit antennas and eight receive antennas are ideally disposed, 64 ((N1+N2)×(M1+M2)) virtual array antennas can be formed, and the aperture length can be maximized. However, in a case where the number of antennas is increased by simply coupling two modules having the same configuration, overlap occurs in the received signals received by the respective receive antennas in a region R1 having the phase difference of 16φ to 31φ. Therefore, the number of virtual antennas remains forty eight as illustrated in FIG. 4.

Specifically, the virtual antenna r1 is formed based on a received signal output from the receive antenna Rx1 of the first module 10 when the transmit antenna Tx1 of the first module 10 transmits a radio wave. The virtual antenna r17 is formed based on a received signal output from the receive antenna Rx5 of the second module 20 when the transmit antenna Tx1 of the first module 10 transmits a radio wave. The phase difference between the virtual antenna r1 and the virtual antenna r17 is determined according to the interval between the receive antenna Rx1 and the receive antenna Rx5. In the example in FIG. 2, the interval between the receive antenna Rx1 and the receive antenna Rx5 is 4dr (=16dt). Therefore, the phase difference between the virtual antenna r1 and the virtual antenna r17 is 16φ.

In addition, the virtual antenna r33 is formed based on a received signal output from the receive antenna Rx1 of the first module 10 when the transmit antenna Tx5 of the second module 20 transmits a radio wave. On the other hand, as described above, the virtual antenna r1 is formed based on a received signal output from the receive antenna Rx1 of the first module 10 when the transmit antenna Tx1 of the first module 10 transmits a radio wave. The phase difference between virtual antenna r1 and virtual antenna r33 is determined according to the interval between the transmit antenna Tx1 and the transmit antenna Tx5. In the example in FIG. 2, the interval between the transmit antenna Tx1 and the transmit antenna Tx5 is 4dr (=16dt). Therefore, the phase difference between the virtual antenna r1 and the virtual antenna r33 is 16φ. Hereinafter, a phase difference between a certain virtual antenna and the virtual antenna r1 will be simply referred to as a phase difference of the certain virtual antenna.

Thus, the phase difference of the virtual antenna r17 and the phase difference of the virtual antenna r33 are both 16φ. In other words, the virtual antenna r17 and the virtual antenna r33 are formed at the same position.

Similarly, the phase difference of each of the virtual antennas r18 to r32 is the same as the phase difference of each of the virtual antennas r34 to r48. That is, the number of virtual antennas to be actually formed is 48 obtained by subtracting the number 16 in which the overlap occurs from the number 64 of all received signals. Although the number of antennas is originally sixty four that can be formed by virtual antennas, the number of virtual antennas is only 48.

Therefore, in the present embodiment, the phases of the radio waves transmitted by the transmit antennas Tx5 to Tx8 of the second module 20 subsequent to the transmit antennas Tx1 to Tx4 of the first module 10 are shifted to reduce the overlap, thereby further increasing the aperture length of the virtual array antenna. Note that “shifting a phase of a signal” includes rotating a phase of the signal, applying phase rotation to the signal, multiplying the signal by a predetermined value, and the like.

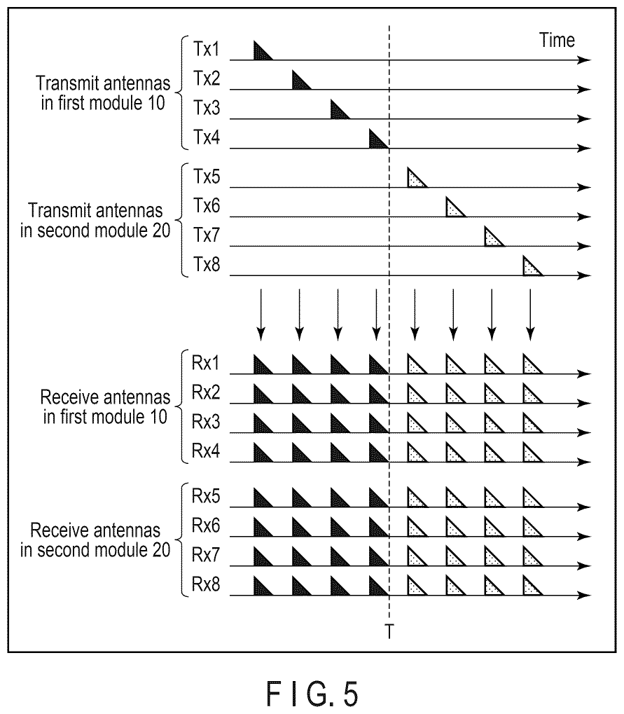

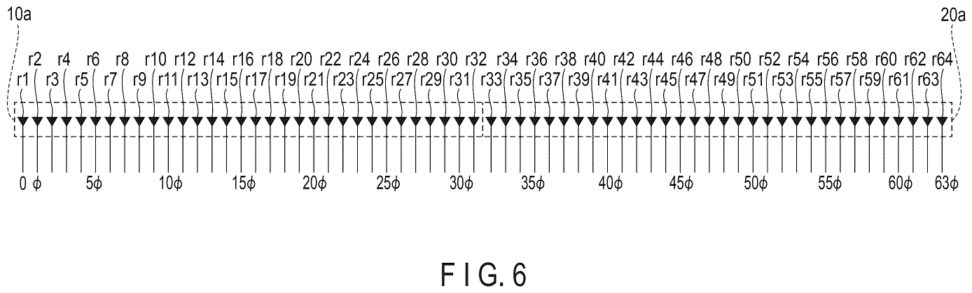

Hereinafter, an operation of the antenna device according to the present embodiment will be described with reference to FIGS. 5 and 6.

FIG. 5 is a diagram illustrating radio wave transmission timings of the transmit antennas Tx1 to Tx8 and reception timings of the receive antennas Rx1 to Rx8 in the first embodiment. A lateral arrow in FIG. 5 indicates a time direction.

Similarly to FIG. 3, the transmit antennas Tx1, Tx2, Tx3, and Tx4 of the first module 10 transmit radio waves based on the reference signal in a time division manner. Thus, all the receive antennas Rx1 to Rx8 of the first module 10 and the second module 20 respectively receive received signals reflected at the target.

The antenna device according to the present embodiment calculates (estimates) the phase difference between the received signals in two adjacent virtual antennas among the virtual antennas r1 to r32 of the first virtual array antenna 10a at a timing T. The timing T is a timing when the transmit antenna Tx4 of the first module 10 finishes transmitting a radio wave. The phase difference φ can be obtained, for example, by comparing a first received signal output from the receive antenna Rx1 with a second received signal output from the receive antenna Rx1. The first received signal is output from the receive antenna Rx1 when a radio wave is transmitted from the transmit antenna Tx1 based on the reference signal. The second received signal is output from the receive antenna Rx1 when a radio wave is transmitted from the transmit antenna Tx2 based on the reference signal.

The antenna device calculates (generates) a phase value indicating a rotation amount of the phase of the radio wave based on array processing information and the phase difference φ. The array processing information indicates the number of virtual antennas in which overlap occurs. The array processing information will be described later. In the example in FIG. 5, since the number of virtual antennas in which overlap occurs is sixteen, the phase value is 1φ or more and 16φ or less. For example, the phase value is 16φ.

The antenna device shifts the phase of the reference signal by the phase value of 16φ, and transmits a radio wave from the transmit antennas Tx5, Tx6, Tx7, and Tx8 of the second module 20 based on the reference signal.

FIG. 6 is a diagram illustrating an example of a virtual array antenna formed by the antenna device according to the first embodiment. Similarly to FIG. 4, the virtual array antenna includes the first virtual array antenna 10a and the second virtual array antenna 20a. 0, φ, . . . , 63φ in FIG. 6 indicate phase differences.

Here, since the phase of the reference signal transmitted from the second module 20 is shifted by 16φ, the phases of the received signals output from the receive antennas Rx1 to Rx8 of the first module 10 and the second module 20 are also shifted by 16φ. That is, each of the virtual antennas r33 to r64 included in the second virtual array antenna 20a is formed to be shifted in the positive direction by 16φ. Note that the “positive direction” is a direction in which the number of antennas in which overlap occurs is decreased. The “negative direction” is a direction in which the number of antennas in which overlap occurs is increased.

Specifically, in the example in FIG. 6, the phase difference of the virtual antenna r33 is 32φ (=16φ+16φ) by receiving the radio wave shifted by 16φ. Similarly, the phase difference of the virtual antenna r34 is 33φ (=17φ+16φ) by receiving the radio wave shifted by 16φ. Similarly, each of the virtual antennas r35 to r64 included in the second virtual array antenna 20a is shifted in the positive direction by 16φ. Thus, as illustrated in FIG. 6, a total of sixty four virtual antennas r1 to r64 of which phase differences do not overlap can be formed.

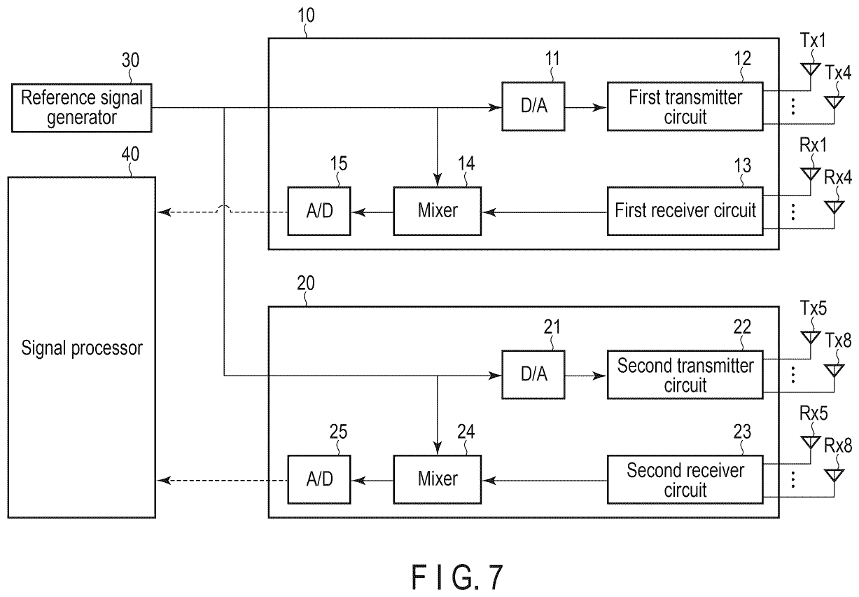

FIG. 7 is a block diagram illustrating an electrical configuration example of an antenna device according to the second comparative example. The antenna device according to the second comparative example includes a reference signal generator 30, the first module 10, the second module 20, and a signal processor 40.

The reference signal generator 30 generates a linear frequency modulated continuous wave (L-FMCW) of which a frequency linearly increases with the lapse of time by, for example, a synthesizer. The L-FMCW signal is also referred to as a chirp signal.

The reference signal generator 30 supplies the generated L-FMCW signal to each of the first module 10 and the second module 20 as a reference signal. Hereinafter, the reference signal supplied to the first module 10 will be referred to as a first reference signal. The reference signal supplied to the second module 20 will be referred to as a second reference signal. The reference signal generator 30 generates the first and second reference signals at different timings and supplies the first and second reference signals to the first and second transmitter circuits 12 and 22, respectively. As a result, the first transmitter circuit 12 transmits the first reference signal to each of the transmit antennas Tx1 to Tx4 at different timings. The second transmitter circuit 22 transmits the second reference signal to each of the transmit antennas Tx5 to Tx8 at different timings.

The first module 10 includes a D/A converter 11, the first transmitter circuit 12, the transmit antennas Tx1 to Tx4, the receive antennas Rx1 to Rx4, a first receiver circuit 13, a mixer 14, and an A/D converter 15. Note that the D/A converter 11 and the first transmitter circuit 12 may be connected to each of the transmit antennas Tx1 to Tx4. The first receiver circuit 13, the mixer 14, and the A/D converter 15 may be connected to each of the receive antennas Rx1 to Rx4.

The first reference signal supplied from the reference signal generator 30 is input to the first transmitter circuit 12 via the D/A converter 11. The first transmitter circuit 12 performs transmission processing such as amplification and frequency conversion on the first reference signal, and supplies the first reference signal after the processing as a transmission signal to each of the transmit antennas Tx1 to Tx4.

The transmit antennas Tx1 to Tx4 transmit the radio waves based on the transmission signal at the constant viewing angle.

The receive antennas Rx1 to Rx4 receive the radio waves reflected from the target. The receive antennas Rx1 to Rx4 output received signals to the first receiver circuit 13. The first receiver circuit 13 performs reception processing such as amplification and frequency conversion on each received signal, and inputs the received signal to a first input terminal of the mixer 14. The first reference signal is input to a second input terminal of the mixer 14.

The mixer 14 multiplies each received signal by the first reference signal to generate an intermediate frequency (IF) signal. The generated IF signal is supplied to the signal processor 40 via the A/D converter 15.

Similarly to the first module 10, the second module 20 also includes a D/A converter 21, a second transmitter circuit 22, the transmit antennas Tx5 to Tx8, the receive antennas Rx5 to Rx8, a second receiver circuit 23, a mixer 24, and an A/D converter 25. Note that the D/A converter 21 and the second transmitter circuit 22 may be connected to each of the transmit antennas Tx5 to Tx8, The second receiver circuit 23, the mixer 24, and the A/D converter 25 may be connected to each of the receive antennas Rx5 to Rx8.

The second reference signal supplied from the reference signal generator 30 is input to the second transmitter circuit 22 via the D/A converter 21. The second transmitter circuit 22 performs transmission processing such as amplification and frequency conversion on the second reference signal, and supplies the second reference signal after the processing as a transmission signal to each of the transmit antennas Tx5 to Tx8.

The transmit antennas Tx5 to Tx8 transmit the radio waves based on the transmission signal at the constant viewing angle.

The receive antennas Rx5 to Rx8 receive the radio waves reflected from the target. The receive antennas Rx5 to Rx8 output from received signals to the second receiver circuit 23. The second receiver circuit 23 performs reception processing such as amplification and frequency conversion on each received signal, and inputs the received signal to a first input terminal of the mixer 24. The second reference signal is input to a second input terminal of the mixer 24. The mixer 24 multiplies each received signal by the second reference signal to generate an IF signal. The generated IF signal is supplied to the signal processor 40 via the A/D converter 25.

The processing of the D/A converter 21, the second transmitter circuit 22, the transmit antennas Tx5 to Tx8, the receive antennas Rx5 to Rx8, the second receiver circuit 23, the mixer 24, and the A/D converter 25 is similar to that of the first module 10.

The signal processor 40 processes the IF signals output from the first module 10 and the second module 20 to form virtual array antennas (virtual antennas r1 to r64) having an antenna interval of the substantially half wavelength d (first interval dt). Specifically, the signal processor 40 obtains an amplitude of a frequency domain signal of the IF signal output from the first module 10 and the second module 20 assuming that 48 receive antennas arranged on the same straight line at the first interval dt are installed. Thus, the signal processor 40 obtains the reflection intensity for a distance from the antenna device to the target.

In this case, since the overlap occurs in the region R1 of the phase difference of 16φ to 30φ of the received signal in the virtual array antenna, the spatial resolution is lowered. Therefore, the antenna device according to the present embodiment has a configuration for shifting phases of signals supplied to the transmit antennas Tx5 to Tx8 of the second module 20, thereby shifting phases of the radio waves transmitted from the transmit antennas Tx5 to Tx8.

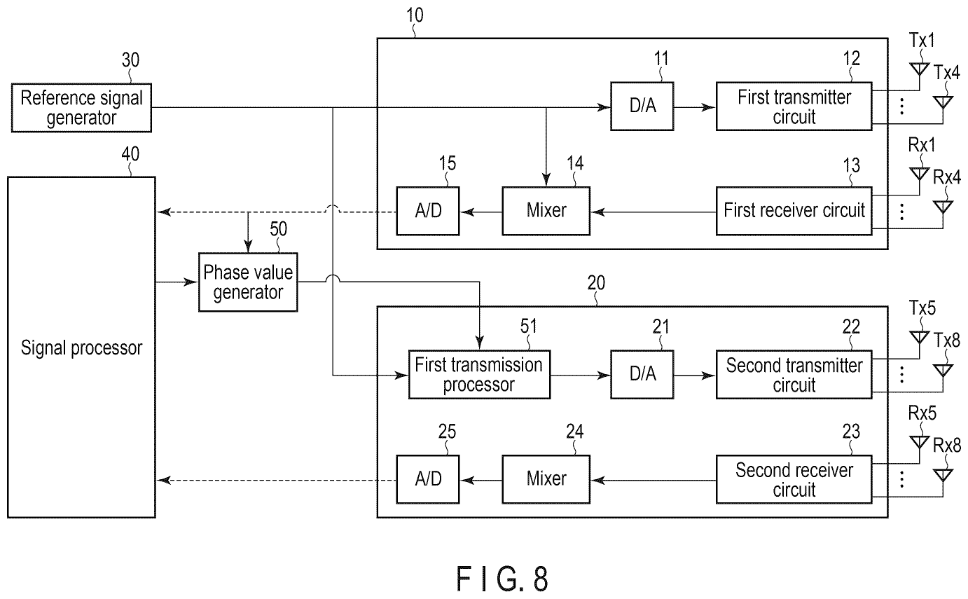

FIG. 8 is a block diagram illustrating an electrical configuration example of the antenna device according to the present embodiment. Note that parts similar to those in the second comparative example are denoted by the same reference numerals, and detailed description thereof will be omitted. The antenna device according to the present embodiment includes a phase value generator 50 in addition to parts of the antenna device according to the second comparative example. The second module 20 includes a first transmission processor 51.

The phase value generator 50 generates the phase value indicating a rotation amount of a phase of a radio wave transmitted from the transmit antennas Tx5 to Tx8 of the second module 20.

Specifically, the phase value generator 50 calculates the phase difference φ between received signals in two adjacent virtual antennas among a plurality of virtual antennas. The plurality of virtual antennas are formed based on received signals output from the receive antennas Rx1 to Rx8 when the transmit antennas Tx1 to Tx4 of the first module 10 transmit radio waves. The phase difference φ is calculated based on the received signals of at least two virtual antennas among the plurality of virtual antennas. Specifically, the phase difference φ can be obtained by comparing a received signal of the virtual antenna r1 with a received signal of the virtual antenna r2. Note that, the received signal of the virtual antenna r1 is a received signal output from the receive antenna Rx1 when the transmit antenna Tx1 transmits a radio wave. The received signal of the virtual antenna r2 is a received signal output from the receive antenna Rx1 when the transmit antenna Tx2 transmits a radio wave.

Alternatively, for example, the phase difference φ may be obtained by dividing a phase difference of the received signal of the virtual antenna r1 and the received signal of the virtual antenna r3 by two. The phase difference of the received signal of the virtual antenna r1 and the received signal of virtual antenna r3 is calculated by comparing the received signal of the virtual antenna r1 with the received signal of the virtual antenna r3. Note that, the received signal of the virtual antenna r3 is a received signal output from the receive antenna Rx1 when the transmit antenna Tx1 transmits a radio wave.

Alternatively, the phase difference φ may be obtained based on received signals of three or more virtual antennas. A method of obtaining the phase difference φ may be a method of calculating the phase difference φ by using two or more pieces of information of various virtual antennas, and is not limited to the method introduced here.

In addition, the phase value generator 50 acquires the array processing information from the signal processor 40. The array processing information indicates the number of virtual antennas in which overlap occurs when no phase rotation amount (phase value) is given to the radio waves transmitted from the transmit antennas Tx5 to Tx8 of the second module 20. The array processing information is determined by at least the number of the coupled modules, the number of the receive antennas included in the modules, and disposition of the transmit antennas included in the modules. For example, when the number of the coupled modules is L, the number of the transmit antennas included in one module is N, and the number of the receive antennas included in one module is M, the array processing information for the l-th module is N×M×(L−1)×(l−1). Note that l, L, N, and M are integers of two or more.

The phase value generator 50 generates a phase value by multiplying the calculated phase difference φ by the acquired array processing information. The phase value is a positive integer multiple of the phase difference φ. The phase value of the reference signal supplied to the l-th module is 1φ or more and N×M×(L−1)×(l−1)×φ or less. For example, the phase value for the l-th module is N×M×(L−1)×(l−1)×φ. In a case where the first module 10 and the second module 20 have the configuration illustrated in FIG. 2, the phase value for the second module 20 is 16φ. The phase value generator 50 outputs the generated phase value to the second module 20.

The first transmission processor 51 of the second module 20 shifts the phase of the second reference signal supplied from the reference signal generator 30 by the phase value output from the phase value generator 50. Thus, the first transmission processor 51 outputs the second reference signal to the second transmitter circuit 22 via the D/A converter 21. Note that the first transmission processor 51 may shift the phase of the second reference signal by using a phase shifter (not illustrated) provided between the D/A converter 21 and the second transmitter circuit 22. The phase shifter may be generally used for calibration and beamforming. In this case, the first transmission processor 51 transmits the phase value output from the phase value generator 50 to the phase shifter. As a result, the phase of the second reference signal after being converted by the D/A converter 21 is shifted by the phase value by the phase shifter. The second reference signal whose phase is shifted by the phase value is output to the second transmitter circuit 22. Each of the transmit antennas Tx5 to Tx8 transmits a radio wave in which the phase of the second reference signal is shifted by the phase value.

As a result, the phases of the received signals output from the receive antennas Rx1 to Rx8 (that is, the phases of virtual antennas r33 to r64) are shifted by the phase value generated by the phase value generator 50 compared with the second comparative example. Here, the phase of the virtual antennas formed as illustrated in FIG. 4 are shifted by the phase value of 16φ. As a result, as illustrated in FIG. 6, 64 virtual antennas with no overlap can be formed.

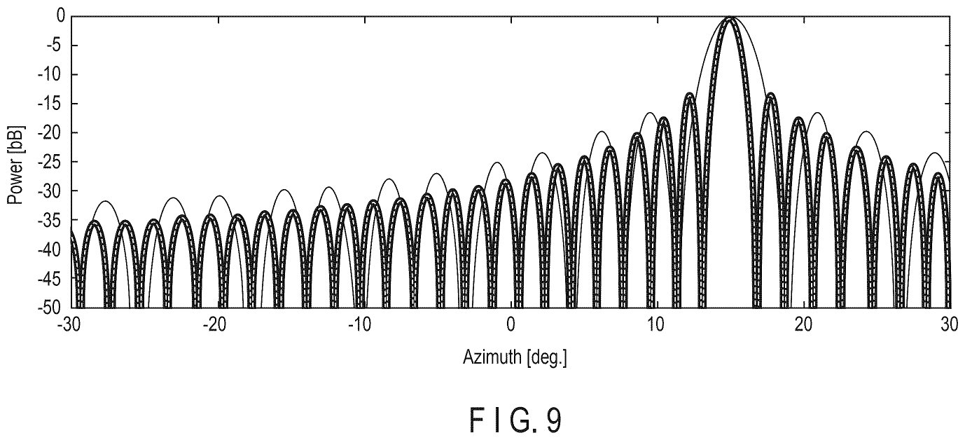

FIG. 9 is a graph illustrating simulation results of estimating a direction of the target in the antenna device according to the first embodiment, the antenna device according to the second comparative example of the first embodiment, and an antenna device of another comparative example having one module in which eight transmit antennas and eight receive antennas are ideally disposed. In the simulation, the target is located at a position of +15 degrees from the antenna device. In FIG. 9, the vertical axis represents a reflection intensity. The horizontal axis in FIG. 9 indicates an angle.

A thin solid line graph indicates a result in a case where the antenna device according to the second comparative example illustrated in FIGS. 3 and 7 is used. A thick solid line graph indicates a result in a case where the antenna device of another comparative example having one module in which eight transmit antennas and eight receive antennas are ideally disposed is used. A dashed line graph indicates a result in a case where the antenna device according to the present embodiment is used.

As illustrated in FIG. 9, it can be seen that the antenna device according to the present embodiment has a spatial resolution (angular resolution) similar to that of the antenna device in a case where the eight transmit antennas and the eight receive antennas are ideally disposed. In addition, it can be seen that the antenna device according to the present embodiment has a higher spatial resolution (angular resolution) than that of the antenna device according to the second comparative example. Note that, although not illustrated, the antenna device according to the present embodiment can obtain a result of a spatial resolution (angular resolution) being similar to that of the antenna device in a case where four transmit antennas and four receive antennas are ideally disposed even in a case where a plurality of targets are present.

As described above, the antenna device according to the present embodiment calculates the phase difference φ between received signals in two adjacent virtual antennas among the plurality of virtual antennas r1 to r32. The plurality of virtual antennas r1 to r32 are formed based on the received signals output from the receive antennas Rx1 to Rx8 (first receive antennas and second receive antennas) when the transmit antennas Tx1 to Tx4 (first transmit antennas) of the first module 10 transmit the radio waves based on the first reference signal. The phase difference φ is calculated based on received signals of at least two virtual antennas among the plurality of virtual antennas. The antenna device generates a phase value based on the phase difference φ. The antenna device shifts the phase of the second reference signal supplied to the transmit antennas Tx5 to Tx8 (second transmit antennas) of the second module 20 by the phase value, thereby shifts the phase of the radio waves transmitted from the transmit antennas Tx5 to Tx8.

As a result, it is possible to form an optimum number of virtual antennas without overlapping portions (that is, no overlap occurs) with respect to the number of transmit antennas and receive antennas. Further, by coupling a plurality of modules having the same configuration as in the present embodiment, the spatial resolution of the antenna device can be easily increased without complicating the wiring.

Note that configurations of the first module 10 and the second module 20 are not limited to those in FIG. 2. The configurations of the first module 10 and the second module 20 may be changed depending on at least a shape and a size of a substrate on which the transmit antennas and the receive antennas are disposed. Hereinafter, another example of configurations of the first module 10 and the second module 20 will be described.

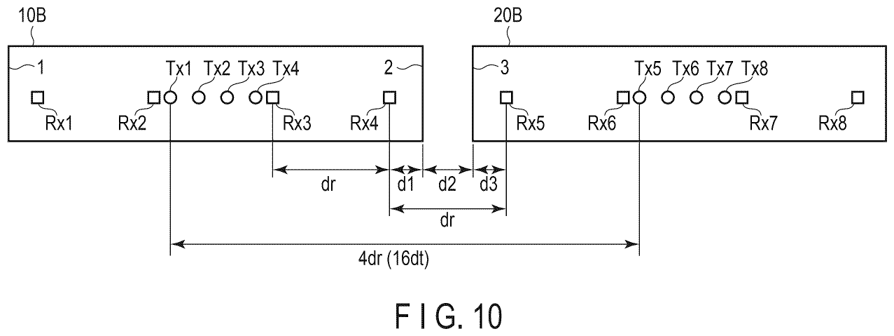

FIG. 10 is a diagram illustrating a first configuration example of a first module 10B and a second module 20B in a configuration example. In the first configuration example, a distance d1 from the receive antenna Rx4 of the first module 10B to the right end 2 is shorter than dr/2 illustrated in FIG. 1. In addition, a distance d3 from the receive antenna Rx5 of the second module 20B to the left end 3 is shorter than dr/2.

In this case, the receive antenna Rx4 closest to the second module 20B among the receive antennas Rx1 to Rx4 of the first module 10B and the receive antenna Rx5 closest to the first module 10B among the receive antennas Rx5 to Rx8 of the second module 20B are disposed such that an interval therebetween is the second interval dr. That is, the receive antenna Rx4 and the receive antenna Rx5 are disposed such that a sum of the distance d1, the distance d3, and a distance d2 between the first module 10B and the second module 20B in FIG. 10 is the second interval dr. Further, the transmit antenna Tx1 closest to the left end 1 of the first module 10B among the transmit antennas Tx1 to Tx4 and the transmit antenna Tx5 closest to the left end 3 of the second module 20B among the transmit antennas Tx5 to Tx8 are disposed such that a distance therebetween is, an integer multiple of the first interval dt. In the example in FIG. 10, the distance is 16dt (4dr).

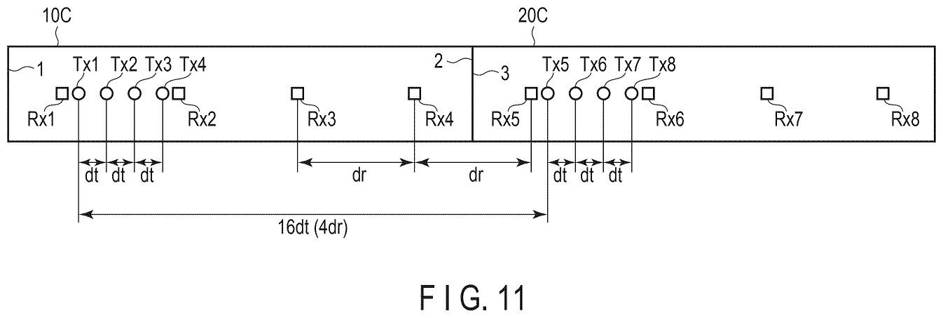

FIG. 11 is a diagram illustrating a second configuration example of a first module 10C and a second module 20C. In FIG. 2, the transmit antennas Tx1, Tx2, Tx3, and Tx4 of the first module 10 are disposed between the receive antenna Rx2 and the receive antenna Rx3. The transmit antennas Tx1, Tx2, Tx3, and Tx4 of the first module 10C in the second configuration example are disposed between the receive antenna Rx1 and the receive antenna Rx2. The transmit antennas Tx5, Tx6, Tx7, and Tx8 of the second module 20C are disposed between the receive antenna Rx5 and the receive antenna Rx6. Further, the transmit antenna Tx1 closest to the left end 1 of the first module 10C among the transmit antennas Tx1 to Tx4 and the transmit antenna Tx5 closest to the left end 3 of the second module 20C among the transmit antennas Tx5 to Tx8 are disposed such that a distance therebetween is, for example, an integer multiple of the first interval dt. In the example in FIG. 11, the distance is 16dt (4dr).

Note that the transmit antennas Tx1, Tx2, Tx3, and Tx4 may be disposed between the receive antenna Rx3 and the receive antenna Rx4, and the transmit antennas Tx5, Tx6, Tx7, and Tx8 may be disposed between the receive antenna Rx7 and the receive antenna Rx8.

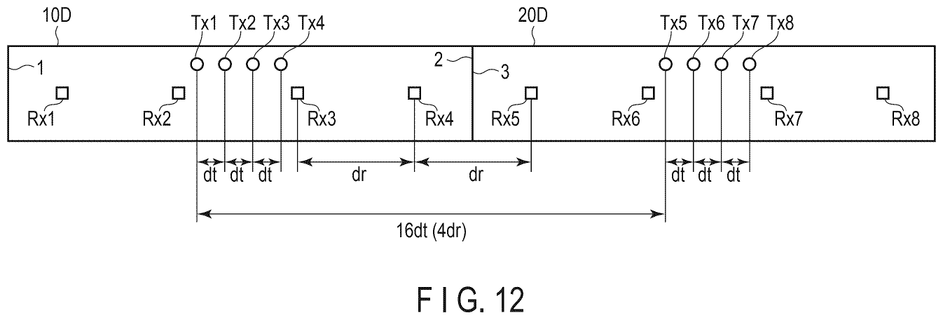

FIG. 12 is a diagram illustrating a third configuration example of a first module 10D and the second module 20D. The transmit antennas Tx1, Tx2, Tx3, and Tx4 and the receive antennas Rx1, Rx2, Rx3, and Rx4 in FIG. 2 are disposed on the same straight line. On the other hand, the transmit antennas Tx1, Tx2, Tx3, and Tx4 of the first module 10D are disposed to be shifted further upward than the receive antennas Rx1, Rx2, Rx3, and Rx4. Similarly, the transmit antennas Tx5, Tx6, Tx7, and Tx8 of the second module 20D are disposed to be shifted further upward than the receive antennas Rx5, Rx6, Rx7, and Rx8. Note that the transmit antennas Tx1, Tx2, Tx3, and Tx4 of the first module 10D in the third configuration example may be disposed to be shifted further downward than the receive antennas Rx1, Rx2, Rx3, and Rx4. Similarly, the transmit antennas Tx5, Tx6, Tx7, and Tx8 of the second module 20D may be disposed to be shifted further downward than the receive antennas Rx5, Rx6, Rx7, and Rx8. The transmit antennas Tx1 to Tx8 are disposed such that distances from the receive antennas Rx1 to Rx8 in the up-down direction are sufficiently smaller than distances between the antenna device and a target. Further, the transmit antenna Tx1 closest to the left end 1 of the first module 10D and the transmit antenna Tx5 closest to the left end 3 of the second module 20D are disposed such that a distance therebetween is, for example, an integer multiple of the first interval dt. In the example in FIG. 12, the distance is 16dt (4dr). As described above, even if the transmit antennas Tx1 to Tx8 and the receive antennas Rx1 to Rx8 are not arranged on the same straight line, in a case where the distance to the target is sufficiently long, the influence of arrangement of the transmit antennas and the receive antennas on the different straight lines can be ignored.

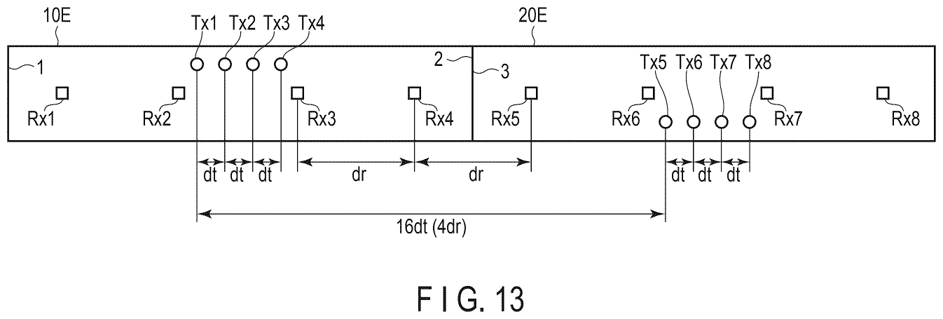

FIG. 13 is a diagram illustrating a fourth configuration example of a first module 10E and a second module 20E. In the example in FIG. 12, the transmit antenna is disposed to be shifted further upward than the receive antenna in both the first module 10C and the second module 20C. On the other hand, in the fourth configuration example, the transmit antennas Tx1, Tx2, Tx3, and Tx4 of the first module 10E are shifted upward, and the transmit antennas Tx5, Tx6, Tx7, and Tx8 of the second module 20E are shifted downward. Note that the transmit antennas Tx1, Tx2, Tx3, and Tx4 of the first module 10E may be shifted downward, and the transmit antennas Tx5, Tx6, Tx7, and Tx8 of the second module 20E may be shifted upward. The transmit antennas Tx1 to Tx8 are disposed such that distances from the receive antennas Rx1 to Rx8 in the up-down direction are sufficiently smaller than distances between the antenna device and the target. In addition, the transmit antenna Tx1 closest to the left end 1 of the first module 10E and the transmit antenna Tx5 closest to the left end 3 of the second module 20E are disposed such that a distance therebetween is, for example, an integer multiple of the first interval dt. In the example in FIG. 13, the distance is 16dt (4dr). As described above, also in the fourth configuration example, even if the transmit antennas Tx1 to Tx8 and the receive antennas Rx1 to Rx8 are not arranged on the same straight line, in a case where the distance to the target is sufficiently long, the influence of arrangement of the transmit antennas and the receive antennas on the different straight lines can be ignored.

Note that configurations of the first module 10 and the second module 20 are not limited to the configurations illustrated in FIGS. 2 and 10 to 13, and any disposition may be employed as long as the virtual array antennas can be formed at equal intervals.

### First Modification Example

A first modification example is different from the first embodiment described above in that virtual antennas are formed to cause overlap to intentionally occur.

The phase value generator 50 according to the first modification example generates a phase value based on the acquired phase difference φ and the array processing information based on the number of virtual antennas that causes overlap. When the number of transmit antennas provided in one module is N, the number of receive antennas is M, and the number of modules to be coupled is L, a phase value for the l-th module is set to, for example, 1 or more and less than N×M×(L−1)×(l−1)×φ.

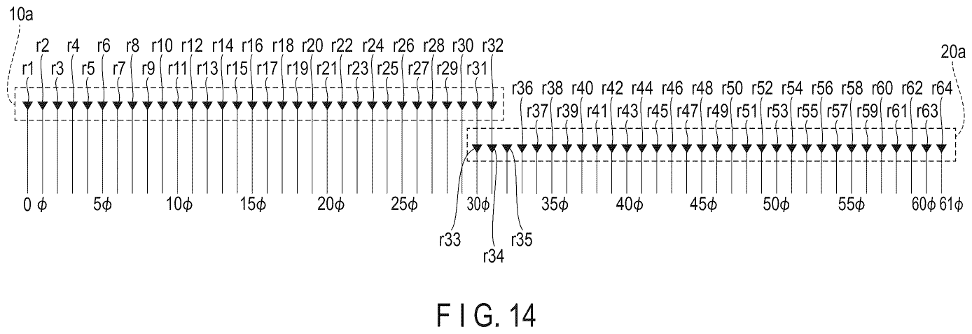

FIG. 14 illustrates an example of a virtual array antenna in the first modification example. 0, φ, . . . , 61φ in FIG. 14 indicate phase differences. Here, an example in a case where the phase value is set to 14φ will be described.

In this case, the transmit antennas Tx5 to Tx8 of the second module 20 transmit radio waves based on the second reference signal of which a phase is shifted by 14φ. As a result, phases of received signals output from the receive antennas Rx1 to Tx8 (that is, phases of virtual antennas r33 to r64) are shifted by the phase value of 14φ compared with those in the second comparative example. As a result, as illustrated in FIG. 14, overlap can be caused in two virtual antennas. Specifically, overlap can be caused in the virtual antennas r31 and r33, and the virtual antennas r32 and r34.

Note that, although setting the phase value to a positive value has been described here, the phase value may be set to a negative value. In this case, since the phases of the received signals output from the receive antennas Rx1 to Rx8 are shifted in the negative direction, the number of antennas in which overlap occurs can be increased compared with the second comparative example.

For example, in a situation where a distance between the antenna device and the target is short, there is a variation in an arrival direction (angle θ) of a reflected wave from the target, so that the virtual array antennas may not be formed at equal intervals. As a result, a result of estimating an angle of the target may vary.

On the other hand, as in the first modification example, it is possible to improve the accuracy of target direction estimation by intentionally causing overlap and complementing a phase with respect to an overlapping portion.

As another utilization example, for example, in a situation in which a target moves, phases of received signals of the virtual antennas that originally overlap each other vary due to the movement of the target. Therefore, it is possible to compensate for the phase variation due to the movement of the target and to improve the accuracy of the target direction estimation by complementing the phases with respect to the virtual antennas originally overlapping.

### Second Embodiment

Next, a second embodiment will be described. In the second embodiment, coupling of three modules will be described.

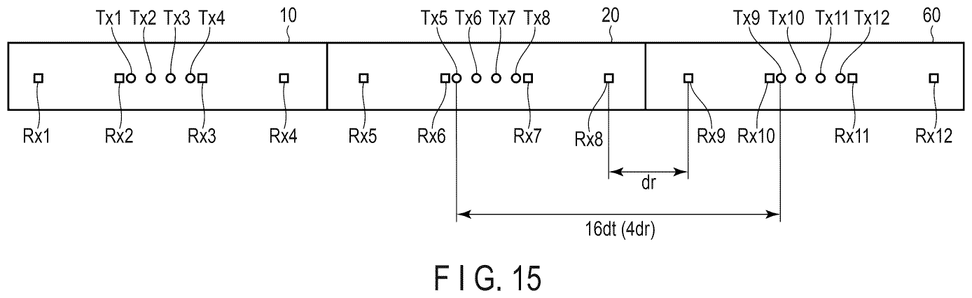

FIG. 15 is a diagram illustrating a configuration example of an antenna device according to the second embodiment. As illustrated in FIG. 15, the antenna device according to the second embodiment includes a third module 60 in addition to the first module 10 and the second module 20.

The third module 60 includes at least one IC, N3 (fifth number) transmit antennas Tx9, Tx10, Tx11, and Tx12, and M3 (sixth number) receive antennas Rx9, Rx10, Rx11, and Rx12. Each of the transmit antennas Tx9, Tx10, Tx11 and Tx12 is connected to the IC. Each of the receive antennas Rx9, Rx10, Rx11, and Rx12 is connected to the IC. In the example in FIG. 15, both N3 and M3 are positive integers, and are four. The disposition of the transmit antennas Tx9, Tx10, Tx11, and Tx12 and the receive antennas Rx9, Rx10, Rx11, and Rx12 is the same as that of the first module 10 and the second module 20. Note that the first module 10, the second module 20, and the third module 60 may be configured on different substrates, or may be disposed on the same substrate.

The first module 10, the second module 20, and the third module 60 are disposed on the same straight line in the X-axis direction. In this case, the second module 20 and the third module 60 are disposed such that an interval between the receive antenna Rx8 closest to the third module 60 among the receive antennas Rx5, Rx6, Rx7, and Rx8 of the second module 20 and the receive antenna Rx9 closest to the second module 20 among the receive antennas Rx9, Rx10, Rx11, and Rx12 of the third module 60 is the second interval dr. A distance between the transmit antenna Tx5 closest to the first module 10 among the transmit antennas Tx5, Tx6, Tx7, and Tx8 and the transmit antenna Tx9 closest to the second module 20 among the transmit antennas Tx9, Tx10, Tx11, and Tx12 is, for example, an integer multiple of the first interval dt. Hereinafter, the distance is assumed to be 16dt (4dr).

A configuration of each antenna of the first module 10, the second module 20, and the third module 60 is not limited to the configuration illustrated in FIG. 15. For example, any or all of the first module 10, the second module 20, and the third module 60 may have the configuration illustrated in any of FIGS. 11 to 13. Alternatively, as illustrated in FIG. 10, a space may be provided between the first module 10, the second module 20, and the third module 60 so that the distance between the receive antennas Rx1 to Rx12 becomes the second interval dr.

Here, an antenna device according to a third comparative example will be described. The antenna device according to the third comparative example is includes the same configuration illustrated in FIG. 15. In the antenna device according to the third comparative example, when the transmit antenna Tx1 of the first module 10 transmits a radio wave, all the receive antennas Rx1 to Rx12 of the first module 10, the second module 20, and the third module 60 receive the radio wave reflected at the target. Next, when the transmit antenna Tx2 of the first module 10 transmits a radio wave, all the receive antennas Rx1 to Rx12 of the first module 10, the second module 20, and the third module 60 receive the radio wave reflected at the target.

Thereafter, in a similar manner, when the transmit antennas Tx3 and Tx4 of the first module 10 transmit radio waves, all the receive antennas Rx1 to Rx12 of the first module 10, the second module 20, and the third module 60 receive the radio waves reflected at the target.

Subsequently, when the transmit antenna Tx5 of the second module 20 transmits a radio wave, all the receive antennas Rx1 to Rx12 of the first module 10, the second module 20, and the third module 60 receive the radio wave reflected at the target. Thereafter, in a similar manner, every time the transmit antennas Tx6, Tx7, and Tx8 of the second module 20 transmit radio waves, all the receive antennas Rx1 to Rx12 of the first module 10, the second module 20, and the third module 60 receive the radio waves reflected at the target.

Subsequently, when the transmit antenna Tx9 of the third module 60 transmits a radio wave, all the receive antennas Rx1 to Rx12 of the first module 10, the second module 20, and the third module 60 receive the radio wave reflected at the target. Thereafter, in a similar manner, every time the transmit antennas Tx10, Tx11, and Tx12 of the third module 60 transmit radio waves, all the receive antennas Rx1 to Rx12 of the first module 10, the second module 20, and the third module 60 receive the radio waves reflected at the target.

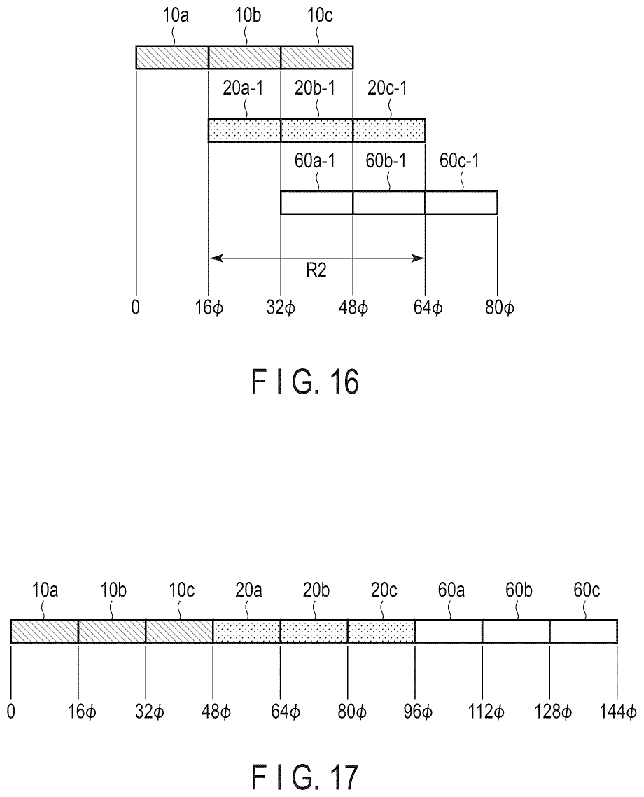

FIG. 16 is a diagram illustrating an example of a virtual antenna formed by the antenna device according to the third comparative example. The antenna device according to the third comparative example forms first virtual array antennas 10a, 10b, and 10c, second virtual array antennas 20a-1, 20b-1, and 20c-1, and third virtual array antennas 60a-1, 60b-1, and 60c-1. 0, 16φ, . . . , 80φ in FIG. 16 indicate phase differences.

The first virtual array antenna 10a includes sixteen virtual antennas formed based on received signals output from the receive antennas Rx1 to Rx4 of the first module 10 when the transmit antennas Tx1 to Tx4 of the first module 10 transmit radio waves. The first virtual array antenna 10b includes sixteen virtual antennas formed based on received signals output from the receive antennas Rx5 to Rx8 of the second module 20 when the transmit antennas Tx1 to Tx4 of the first module 10 transmit radio waves. The first virtual array antenna 10c includes sixteen virtual antennas formed based on received signals output from the receive antennas Rx9 to Rx12 of the third module 60 when the transmit antennas Tx1 to Tx4 of the first module 10 transmit radio waves.

Similarly, the second virtual array antenna 20a-1 includes sixteen virtual antennas formed based on received signals output from the receive antennas Rx1 to Rx4 of the first module 10 when the transmit antennas Tx5 to Tx8 of the second module 20 transmit radio waves. The second virtual array antenna 20b-1 includes sixteen virtual antennas formed based on received signals output from the receive antennas Rx5 to Rx8 of the second module 20 when the transmit antennas Tx5 to Tx8 of the second module 20 transmit radio waves. The second virtual array antenna 20c-1 includes sixteen virtual antennas formed based on received signals output from the receive antennas Rx9 to Rx12 of the third module 60 when the transmit antennas Tx5 to Tx8 of the second module 20 transmit radio waves.

In addition, the third virtual array antenna 60a-1 includes sixteen virtual antennas formed based on received signals output from the receive antennas Rx1 to Rx4 of the first module 10 when the transmit antennas Tx9 to Tx12 of the third module 60 transmit radio waves. The third virtual array antenna 60b-1 includes sixteen virtual antennas formed based on received signals output from the receive antennas Rx5 to Rx8 of the second module 20 when the transmit antennas Tx9 to Tx12 of the third module 60 transmit radio waves. The third virtual array antenna 60c-1 includes sixteen virtual antennas formed based on received signals output from the receive antennas Rx9 to Rx12 of the third module 60 when the transmit antennas Tx9 to Tx12 of the third module 60 transmit radio waves.

Here, for example, if N transmit antennas and M receive antennas are ideally disposed to each have multiples of L, N×L×M×L virtual array antennas can be formed, and the aperture length can be maximized. However, in a case where the number of antennas is increased by simply coupling L modules having the same configuration, the number of virtual antennas remains N×M×(2L−1). This is because, for example, in a case where the number of modules to be coupled is three, as illustrated in FIG. 16, in a region R2 having phase differences of 16φ to 64φ, overlap occurs in received signals output from the respective receive antennas.

Therefore, in the second embodiment, phases of the radio waves transmitted by the transmit antennas Tx5 to Tx8 of the second module 20 subsequent to the transmit antennas Tx1 to Tx4 of the first module 10 and phases of the radio waves transmitted by the transmit antennas Tx9 to Tx12 of the third module 60 are shifted to reduce the overlap, thereby further increasing the aperture length of the virtual array antenna.

FIG. 17 is a diagram illustrating an example of a virtual array antenna formed by the antenna device according to the second embodiment. The antenna device according to the second embodiment forms the first virtual array antennas 10a, 10b, and 10c, second virtual array antennas 20a, 20b, and 20c, and third virtual array antennas 60a, 60b, and 60c. 0, 16φ, . . . , 144φ in FIG. 17 indicate phase differences. Here, phases of radio waves transmitted by the transmit antennas Tx5 to Tx8 of the second module 20 are shifted by 32φ. In addition, phases of radio waves transmitted by the transmit antennas Tx9 to Tx12 of the third module 60 are shifted by 64φ.

The phase of the radio wave transmitted from the second module 20 is shifted by 32φ, so that the received signals output from the receive antennas Rx1 to Rx12 are also shifted by 32φ. As a result, each of the virtual antennas included in the second virtual array antennas 20a-1, 20b-1, and 20c-1 is shifted in the positive direction by 32φ. As a result, each of the virtual antennas included in the second virtual array antennas 20a, 20b, and 20c can be formed not to overlap each of the virtual antennas included in the first virtual array antennas 10a, 10b, and 10c.

The phase of the radio wave transmitted from the third module 60 is shifted by 64φ, so that the received signals output from the receive antennas Rx1 to Rx12 are also shifted by 64φ. As a result, each of the virtual antennas included in the third virtual array antennas 60a-1, 60b-1, and 60c-1 is shifted in the positive direction by 64φ. As a result, the third virtual array antennas 60a, 60b, and 60c can be formed not to overlap the first virtual array antennas 10a, 10b, and 10c and the second virtual array antennas 20b and 20c.

Therefore, according to the second embodiment, a total of one hundred and forty four virtual array antennas can be formed.

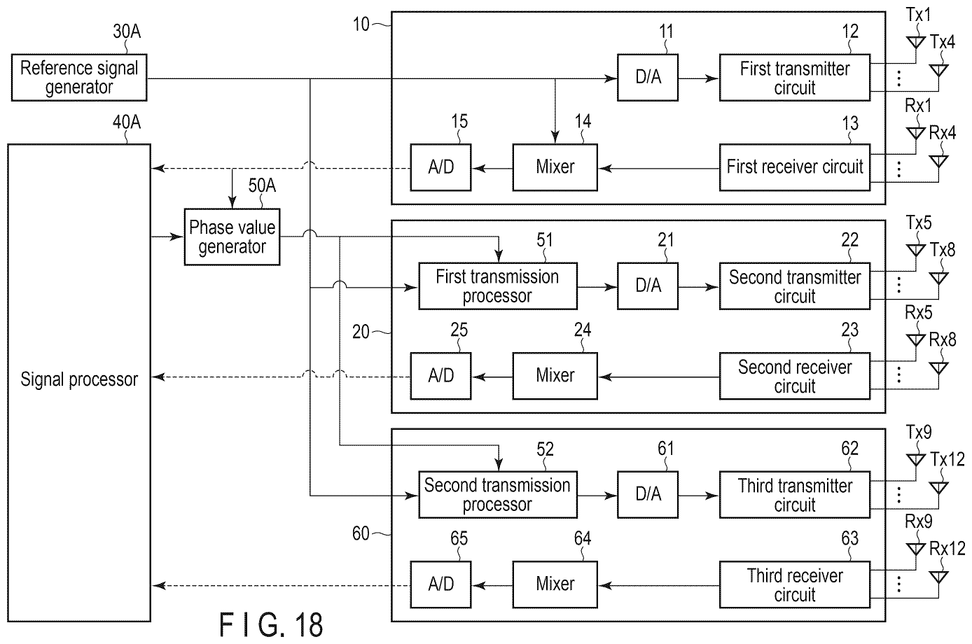

FIG. 18 is a block diagram illustrating an electrical configuration example of the antenna device according to the second embodiment. Note that parts similar to those in the first embodiment are denoted by the same reference numerals, and detailed description thereof will be omitted.

The antenna device according to the second embodiment includes a reference signal generator 30A, the first module 10, the second module 20, a third module 60, a signal processor 40A, and a phase value generator 50A. The reference signal generator 30A supplies a generated reference signal (L-FMCW signal) to the third module 60 in addition to the first module 10 and the second module 20. Hereinafter, the reference signal supplied to the third module 60 will be referred to as a third reference signal.

The third module 60 includes a D/A converter 61, a third transmitter circuit 62, transmit antennas Tx9 to Tx12, receive antennas Rx9 to Rx12, a third receiver circuit 63, a mixer 64, an A/D converter 65, and a second transmission processor 52. The processing of the D/A converter 61, the third transmitter circuit 62, the transmit antennas Tx9 to Tx12, the receive antennas Rx9 to Rx12, the third receiver circuit 63, the mixer 64, and the A/D converter 65 is similar to that of the first module 10 and that of the second module 20.

Here, the phase value generator 50A generates a first phase value and a second phase value. The first phase value is a rotation amount of the phases of the radio waves transmitted by the transmit antennas Tx5 to Tx8 of the second module 20. The second phase value is a rotation amount of the phases of the radio waves transmitted by the transmit antennas Tx9 to Tx12 of the third module 60.

Specifically, the phase value generator 50A calculates the phase difference φ between received signals in two adjacent virtual antennas among a plurality of virtual antennas (first virtual array antenna 10a) formed based on received signals output from the receive antennas Rx1 to Rx4 of the first module 10 when the transmit antennas Tx1 to Tx4 of the first module 10 transmit radio waves. A method of obtaining the phase difference φ is similar to that in the first embodiment.

In addition, the phase value generator 50A acquires first array processing information corresponding to the second module 20 and second array processing information corresponding to the third module 60 from the signal processor 40A. Each of the first and second array processing information is information indicating the number of virtual antennas that overlap. The array processing information is determined by at least the number of modules to be coupled, the number of receive antennas included in the modules, the number of transmit antennas included in the modules, disposition of the receive antennas, and disposition of the transmit antennas. For example, when the number of coupled modules is L, the number of transmit antennas included in one module is N, and the number of receive antennas included in one module is M, the l-th array processing information corresponding to the l-th module is N×M×(L−1)×(l−1).

The phase value generator 50A generates a first phase value by multiplying the calculated phase difference φ by the acquired first array processing information. The phase value generator 50A outputs the generated first phase value to the second module 20. In addition, the phase value generator 50A generates a second phase value by multiplying the calculated phase difference φ by the acquired second array processing information. The phase value generator 50A outputs the generated second phase value to the third module 60. Note that the l-th phase value of the phase of the reference signal supplied to the l-th module among the L modules is, for example, N×M×(L−1)×(l−1)×φ.

The first transmission processor 51 of the second module 20 shifts the phase of the second reference signal supplied from the reference signal generator 30A by the first phase value output from the phase value generator 50A. Thus, the first transmission processor 51 outputs the second reference signal to the second transmitter circuit 22 via the D/A converter 21. The transmit antennas Tx5 to Tx8 transmit radio waves based on the second reference signal whose phase is shifted by the first phase value. Similarly to the first embodiment, the first transmission processor 51 may shift the phase of the second reference signal by using a phase shifter (not illustrated) provided between the D/A converter 21 and the second transmitter circuit 22.

Similarly, the second transmission processor 52 of the third module 60 shifts the phase of the third reference signal supplied from the reference signal generator 30A by the second phase value output from the phase value generator 50A. Thus, the second transmission processor 52 outputs the third reference signal to the third transmitter circuit 62 via the D/A converter 61. The transmit antennas Tx9 to Tx12 transmit radio waves based on the third reference signal whose phase is shifted by the second phase value. Similarly to the first embodiment, the second transmission processor 52 may shift the phase of the third reference signal by using a phase shifter (not illustrated) provided between the D/A converter 61 and the third transmitter circuit 62.

In the second embodiment, the case where three modules are coupled has been described, but four or more modules may be coupled according to a similar method. In this case, when the radio wave is transmitted by the transmit antenna of the first module, a phase value corresponding to each of the second and subsequent modules is generated based on the phase difference of the received signal output from the receive antenna of the first module. For example, in a case where L modules are coupled, a phase value corresponding to the l-th module is 1 or more and N×M×(L−1)×(l−1)×φ or less as a shift amount of the phase of the reference signal supplied to the l-th module. Based on the phase difference, a phase of a radio wave based on the reference signal and transmitted by the second and subsequent modules is shifted by the phase value corresponding to the module. As a result, modules can be further coupled, and the aperture length of the virtual antenna can be efficiently increased.

### Second Modification Example

In the second embodiment, both the first phase value and the second phase value are generated based on the received signals output from the receive antennas Rx1 to Rx4 of the first module 10. A second modification example is different from the second embodiment in that the second phase value is generated based on received signals output from the receive antennas Rx5 to Rx8 of the second module 20.

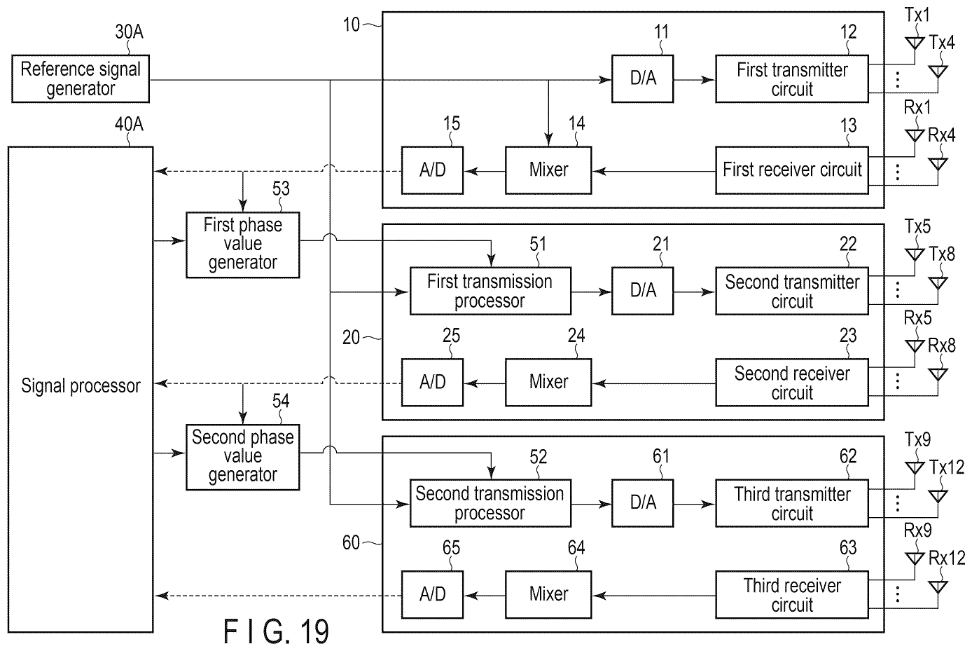

FIG. 19 is a block diagram illustrating an electrical configuration example of an antenna device according to the second modification example. Note that parts similar to those in the second embodiment described above are denoted by the same reference numerals, and detailed description thereof will be omitted.

The antenna device according to the second modification example includes a first phase value generator 53 and a second phase value generator 54 instead of the phase value generator 50 of the second embodiment.

The first phase value generator 53 calculates a first phase difference φ1 between two adjacent virtual antennas among the plurality of virtual antennas included in the first virtual array antenna 10a. The plurality of virtual antennas are formed based on received signals output from the receive antennas Rx1 to Rx4 of the first module 10 when the transmit antennas Tx1 to Tx4 of the first module 10 transmit radio waves. The first phase value generator 53 generates a first phase value based on the calculated first phase difference φ1 and the first array processing information acquired from the signal processor 40A. The first phase value generator 53 outputs the generated first phase value to the second module 20.

The first transmission processor 51 of the second module 20 shifts the phase of the second reference signal supplied from the reference signal generator 30A by the first phase value output from the phase value generator 50. The first transmission processor 51 outputs the second reference signal to the second transmitter circuit 22 via the D/A converter 21. The transmit antennas Tx5 to Tx8 transmit radio waves based on the second reference signal whose phase is shifted by the first phase value.

The second phase value generator 54 calculates a second phase difference φ2 between two adjacent virtual antennas among the plurality of virtual antennas included in the first virtual array antenna 10b. The plurality of virtual antennas are formed based on received signals output from the receive antennas Rx5 to Rx8 of the second module 20 when the transmit antennas Tx1 to Tx4 of the first module 10 transmit radio waves. The second phase value generator 54 generates a second phase value based on the calculated second phase difference φ2 and the second array processing information acquired from the signal processor 40A. The second phase value generator 54 outputs the generated second phase value to the third module 60.

The second transmission processor 52 of the third module 60 shifts the phase of the third reference signal supplied from the reference signal generator 30A by the second phase value output from the second phase value generator 54. The second transmission processor 52 outputs the third reference signal to the third transmitter circuit 62 via the D/A converter 61. The transmit antennas Tx9 to Tx12 transmit radio waves based on the third reference signal whose phase is shifted by the second phase value.

As described above, in the second modification example, the second phase value output to the third module 60 is generated based on the received signals output from the receive antennas Rx5 to Rx8 of the second module 20. As a result, since the received signals output from the receive antennas Rx5 to Rx8 of the second module 20 closer to the third module 60 can be used, the accuracy of the angle estimation can be improved compared with the case of using the received signals output from the receive antennas Rx1 to Rx4 of the first module 10. The second modification example is effective, for example, when there is fluctuation (movement) in the target.

### Third Embodiment

In the first embodiment, the aperture length of the virtual array antenna is increased by shifting the phase of the transmission signal (reference signal) at the time of transmitting the radio wave. The third embodiment is different from the first embodiment described above in that the aperture length of the virtual array antenna is increased by shifting the phase of the received signal received at the time of receiving a radio wave.

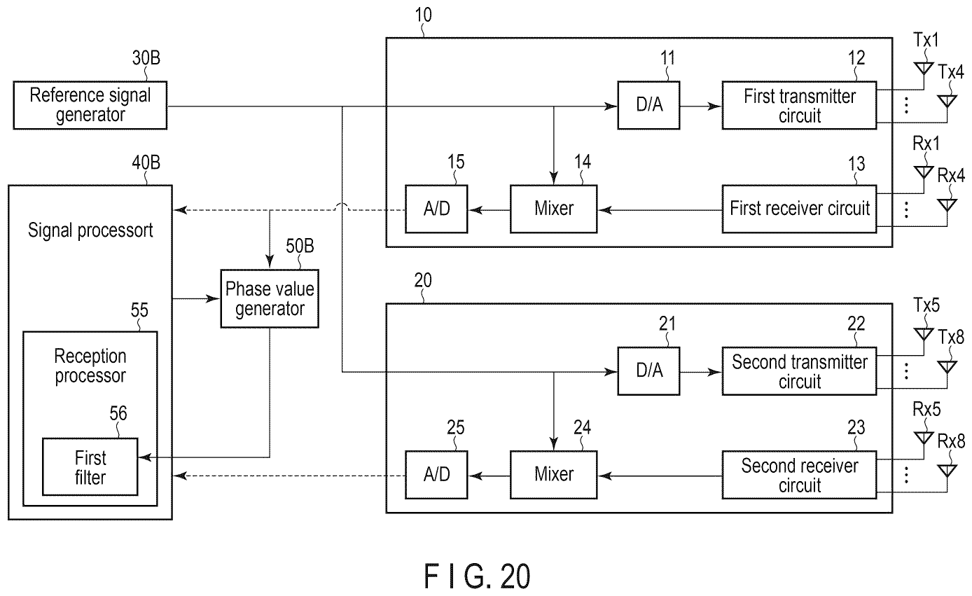

FIG. 20 is a block diagram illustrating an electrical configuration example of an antenna device according to the third embodiment. Note that parts similar to those in the first embodiment are denoted by the same reference numerals, and detailed description thereof will be omitted. In addition, here, a case where the first module 10 and the second module 20 are coupled and disposed as illustrated in FIG. 2 will be described. Further, the transmit antennas Tx1 to Tx4 of the first module 10 and the transmit antennas Tx5 to Tx8 of the second module 20 are time-divisionally driven. Specifically, the transmit antennas Tx1 to Tx4 of the first module 10 sequentially transmit radio waves, and then the transmit antennas Tx5 to Tx8 of the second module 20 sequentially transmit radio waves. In addition, when the transmit antennas Tx1 to Tx8 transmit radio waves, all the receive antennas Rx1 to Rx8 receive the radio waves reflected at a target.

The antenna device according to the third embodiment includes a reference signal generator 30B, the first module 10, the second module 20, a signal processor 40B, and a phase value generator 50B.

The phase value generator 50B calculates a phase difference φ between received signals in two adjacent virtual antennas among a plurality of virtual antennas. The plurality of virtual antennas formed based on received signals output from the receive antennas Rx1 to Rx8 when the transmit antennas Tx1 to Tx4 of the first module 10 transmit radio waves. In addition, the phase value generator 50B acquires array processing information from the signal processor 40B. The phase value generator 50B generates a phase value by multiplying the phase difference φ by the array processing information. The generation of the phase value is similar to that of the first embodiment described above.

Here, the phase value generator 50B outputs the generated phase value to the signal processor 40B. That is, in the third embodiment, the second module 20 transmits a radio wave from the transmit antennas Tx5 to Tx8 based on the second reference signal whose phase is not shifted.

The receive antennas Rx1 to Rx8 receive radio waves reflected at the target. The received signals output from the receive antennas Rx1 to Rx8 are supplied to the signal processor 40B via the mixers 14 and 24 and the A/D converters 15 and 25.

The signal processor 40B includes a reception processor 55. The reception processor 55 includes a first filter 56 that shifts a phase of the received signal based on the phase value output from the phase value generator 50B. The reception processor 55 inputs the received signals output from the first module 10 and the second module 20 to the first filter 56.

The first filter 56 shifts a phase of each of the input received signals by the phase value generated by the phase value generator 50B. As a result, similarly to the first embodiment in which a phase is shifted at the time of transmission, sixty four virtual antennas with no overlap can be formed.

According to the third embodiment, it is not necessary to provide the first transmission processor 51 in the second module 20. Therefore, a configuration of each module can be simplified compared with the first embodiment.

### Third Modification Example

In a third modification example, an aspect will be described in which a phase of a received signal is shifted at the time of receiving a radio wave in a case where three modules are coupled.

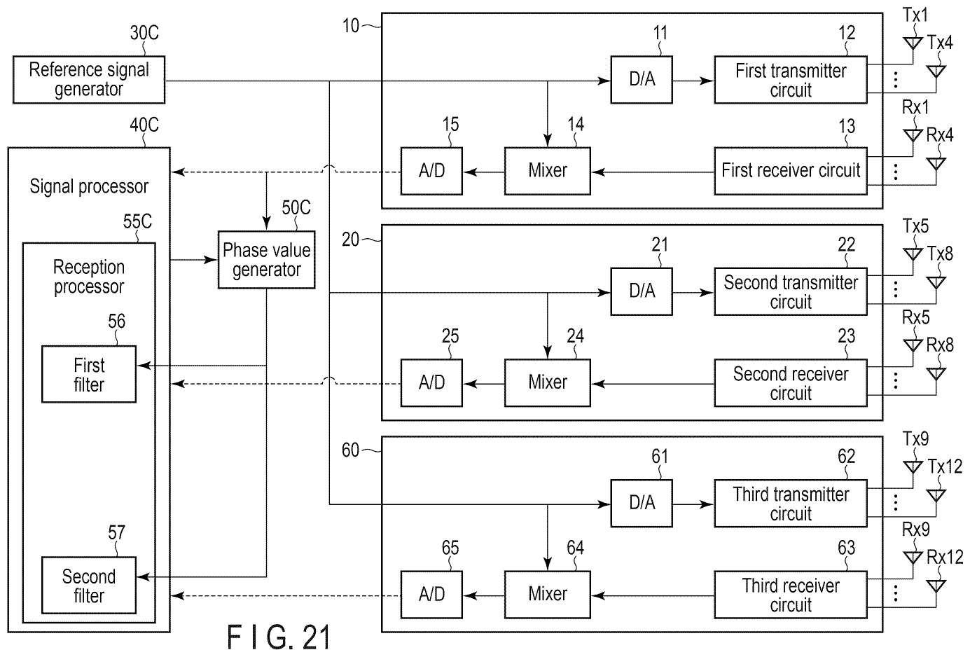

FIG. 21 illustrates an electrical configuration example of an antenna device according to the third modification example. The same parts as those of the second and third embodiments are denoted by the same reference numerals, and a detailed description thereof will be omitted. In addition, here, a case where the first module 10, the second module 20, and the third module 60 are coupled and disposed as illustrated in FIG. 15 will be described.

An operation is performed such that the transmit antennas Tx1 to Tx4 of the first module 10, the transmit antennas Tx5 to Tx8 of the second module 20, and the transmit antennas Tx9 to Tx12 of the third module 60 are time-divisionally driven. Specifically, the transmit antennas Tx1 to Tx4 of the first module sequentially transmit radio waves. Next, the transmit antennas Tx5 to Tx8 of the second module sequentially transmit radio waves, and then the transmit antennas Tx9 to Tx12 of the third module 60 sequentially transmit radio waves. When the transmit antenna Tx1 transmits a radio wave, all the receive antennas Rx1 to Rx12 receive the radio wave reflected at the target. Similarly, when each of the transmit antennas Tx2 to Tx12 transmits a radio wave, all the receive antennas Rx1 to Rx12 receive the radio wave reflected at the target.

The antenna device according to the third modification example includes a reference signal generator 30C, the first module 10, the second module 20, the third module 60, a signal processor 40C, and a phase value generator 50C.

Similarly to the second embodiment, the phase value generator 50C calculates the phase difference between received signals in two adjacent virtual antennas among a plurality of virtual antennas (first virtual array antenna 10a). The plurality of virtual antennas are formed based on received signals output from the receive antennas Rx1 to Rx4 of the first module 10 when the transmit antennas Tx1 to Tx4 of the first module 10 transmit radio waves. The phase value generator 50C generates a first phase value based on the phase difference φ and the first array processing information corresponding to the second module 20 and acquired from the signal processor 40C.

In addition, the phase value generator 50C generates a second phase value based on the phase difference φ and the second array processing information corresponding to the third module 60 and acquired from the signal processor 40C.

The phase value generator 50C outputs the generated first phase value and second phase value to the signal processor 40C.

The reception processor 55C of the signal processor 40C includes a first filter 56 that shifts a phase of a received signal based on the first phase value output from the phase value generator 50C. The reception processor 55C inputs received signals output from the receive antennas Rx1 to Rx12 of the first module 10, the second module 20, and the third module 60 to the first filter 56 when radio waves are transmitted by the transmit antennas Tx5 to Tx8 of the second module 20. The first filter 56 shifts a phase of each of the input received signals by the first phase value generated by the phase value generator 50C.

As a result, the second virtual array antennas 20a, 20b, and 20c in which phases do not overlap the phases in the first virtual array antennas 10a, 10b, and 10c are formed, similarly to the case of shifting phases at the time of transmission illustrated in FIG. 17 (second embodiment).

Furthermore, the reception processor 55C of the signal processor 40C includes a second filter 57 that shifts a phase of a received signal based on the second phase value output from the phase value generator 50C. The reception processor 55C inputs received signals output from the receive antennas Rx1 to Rx12 of the first module 10, the second module 20, and the third module 60 to the second filter 57 when radio waves are transmitted by the transmit antennas Tx9 to Tx12 of the third module 60. The second filter 57 shifts a phase of each of the input received signals by the second phase value generated by the phase value generator 50C.

As a result, the third virtual array antennas 60a, 60b, and 60c that do not overlap the first virtual array antennas 10a, 10b, and 10c and the second virtual array antennas 20a, 20b, and 20c are formed, similarly to the case of shifting phases at the time of transmission illustrated in FIG. 17 (the second embodiment).

### Fourth Modification Example

In the third modification example, both the first phase value and the second phase value are generated based on the received signals output from the receive antennas Rx1 to Rx4 of the first module 10. The fourth modification example is different from the third modification example in that a second phase value is generated based on received signals output from the receive antennas Rx5 to Rx8 of the second module 20.

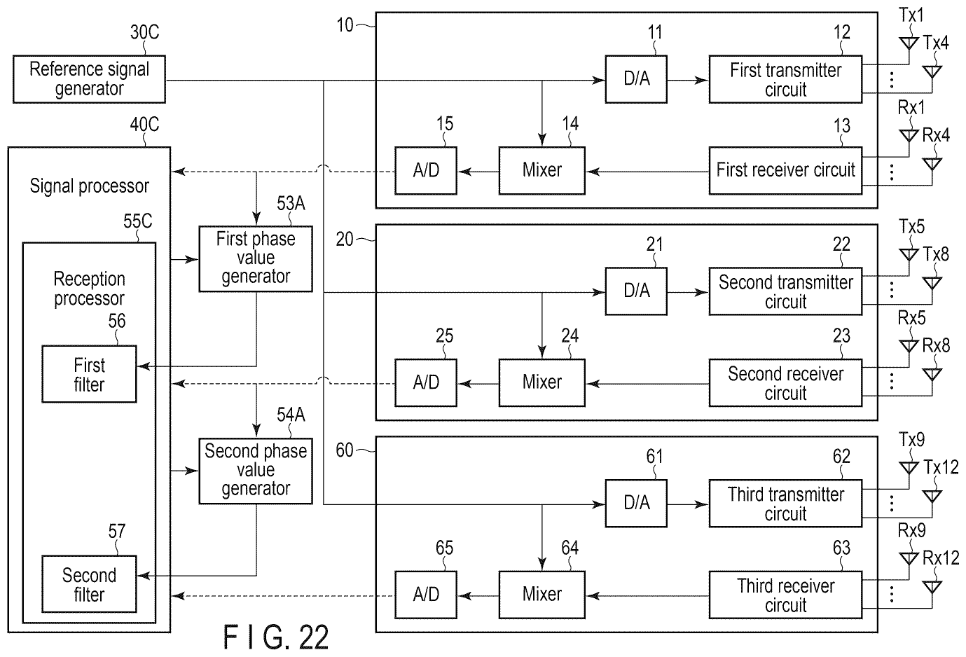

FIG. 22 is a block diagram illustrating an electrical configuration example of an antenna device according to the fourth modification example. Note that parts similar to those in the second and third modification examples described above are denoted by the same reference numerals, and detailed description thereof will be omitted.

The antenna device according to the fourth modification example includes a first phase value generator 53A and a second phase value generator 54A instead of the phase value generator 50C of the third modification example.

The first phase value generator 53A calculates a first phase difference φ1 between two adjacent virtual antennas among a plurality of virtual antennas included in the first virtual array antenna 10a. The plurality of virtual antennas are formed based on received signals output from the receive antennas Rx1 to Rx4 of the first module 10 when the transmit antennas Tx1 to Tx4 of the first module 10 transmit radio waves. The first phase value generator 53A generates a first phase value based on the calculated first phase difference φ1 and the first array processing information acquired from the signal processor 40C. The first phase value generator 53A outputs the generated first phase value to the signal processor 40C.

In addition, the second phase value generator 54A calculates a second phase difference φ2 between two adjacent virtual antennas among a plurality of virtual antennas included in the first virtual array antenna 10b. The plurality of virtual antennas formed based on received signals output from the receive antennas Rx5 to Rx8 of the second module 20 when the transmit antennas Tx1 to Tx4 of the first module 10 transmit radio waves. The second phase value generator 54 generates a second phase value based on the calculated second phase difference φ2 and the second array processing information acquired from the signal processor 40C. The second phase value generator 54A generates the second phase value based on the second phase difference φ2 and the second array processing information corresponding to the third module 60 and acquired from the signal processor 40C. The second phase value generator 54A outputs the generated second phase value to the signal processor 40C.

The processing of the signal processor 40C is similar to that of the third modification example. That is, the reception processor 55C of the signal processor 40C includes a first filter 56 that shifts a phase of a received signal based on the first phase value. The first filter 56 shifts a phase of each of received signals output from the receive antennas Rx1 to Rx12 by the first phase value when the transmit antennas Tx5 to Tx8 of the second module 20 transmit radio waves.

Similarly, the reception processor 55C includes a second filter 57 that shifts a phase of a received signal based on the second phase value. The second filter 57 shifts a phase of each of received signals output from the receive antennas Rx1 to Rx12 by the second phase value when the transmit antennas Tx9 to Tx12 of the third module 60 transmit radio waves.

As a result, similarly to the third modification example, it is possible to form a virtual array antenna in which the respective virtual antennas do not overlap (overlap does not occur).

Also in the second embodiment, the second modification example, the third embodiment, the third modification example, and the fourth modification example described above, as in the first modification example, by setting a phase value corresponding to each module to 1 or more and less than N×M×(L−1)×(l−1)×φ, the overlap may be intentionally generated.

### Application Examples

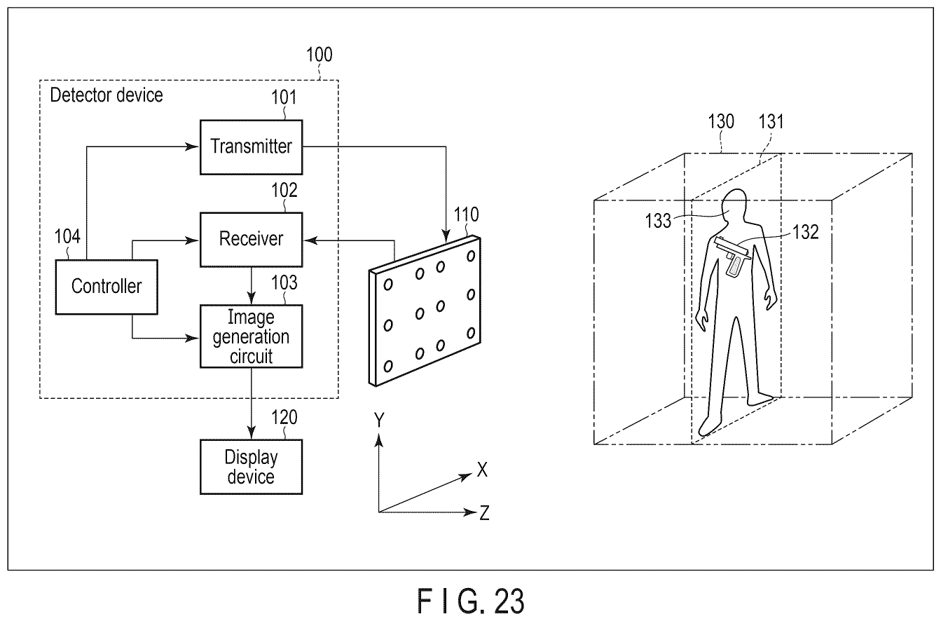

The antenna device according to the above-described embodiments can be applied to the following electronic device. FIG. 23 illustrates an application example of the antenna device according to the above-described embodiments. This electronic device includes an array antenna 110 disposed to face a target (for example, a person) 133, a detector device 100 connected to the array antenna 110, and a display device 120 connected to the detector device 100. The array antenna 110 includes a plurality of modules (transmit antennas and receive antennas) of the above-described embodiments. A size of the array antenna 110 corresponds to a size of the target 133. The size is, for example, the number of modules to be coupled. Radio waves are radiated from the array antenna 110 in the Z direction orthogonal to the antenna substrate.

The detector device 100 can obtain an image of the target 133 in a plane 131 that is a plane in a three-dimensional space 130 located in the transmission direction of the radio waves transmitted from the array antenna 110 and is parallel to the array antenna 110. A position of the plane 131 from which the image is obtained corresponds to the time from transmission to reception of the radio waves. By setting the time from the transmission to the reception of the radio waves according to positions of a large number of planes 131 in the three-dimensional space 130 and obtaining images of the planes 131 at a large number of different positions, a three-dimensional image of the target 133 can be obtained. As an example of use of the detector device 100, there is a body check of a user at an airport, a station, or the like.

The detector device 100 includes a transmitter 101 and a receiver 102 connected to each antenna included in the array antenna 110. The transmitters 101 or the receivers 102 may be prepared as many as the number of antennas, and the transmitters 101 or the receivers 102 may be connected to the antennas, respectively. Alternatively, the transmitters 101 or the receivers 102 may be prepared as many as the number less than the number of antennas, and the transmitters 101 or the receivers 102 may be connected to a plurality of antennas in common via a selector.

The transmitter 101 and the receiver 102 are controlled by a controller 104. The transmitter 101 and the receiver 102 are connected to the controller 104 in a wired or wireless manner. The controller 104 controls a transmission frequency and a band of the transmitter 101, a transmission timing for each antenna, and the like, and controls a reception timing (time from transmission to reception) of the receiver 102 for each antenna, and the like. A received signal of one antenna corresponds to an image signal of one pixel of the target 133, and the controller 104 sequentially changes an antenna (also referred to as scanning) and changes a reception timing. A reflected wave of the radio wave transmitted from each transmit antenna at the target 133 is received by the receive antenna.

The received signal output from the receiver 102 is supplied to the image generation circuit 103, and an image signal indicating a three-dimensional image of the target 133 is generated. The receiver 102 and the image generation circuit 103 are connected in a wired or wireless manner. The image generation circuit 103 is also controlled by the controller 104. As an image reconstruction algorithm of the image generation circuit 103, a time domain method, a frequency domain method, or any other algorithm may be used.

The image signal generated by the image generation circuit 103 is supplied to the display device 120 and displayed. By observing this image, it is possible to detect that the target 133 possesses a dangerous article (for example, a gun) 132. The image generation circuit 103 and the display device 120 are also connected in a wired or wireless manner.

According to at least one embodiment described above, it is possible to provide the antenna device and the control method capable of adjusting the improvement in a spatial resolution of virtual array antennas and the improvement in the accuracy of target direction estimation in the virtual array antennas according to the purpose.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna device comprising:
a reference signal generator;
a first module to which a first reference signal is supplied from the reference signal generator;
a second module to which a second reference signal is supplied from the reference signal generator; and
a phase value generator, wherein,
the first module comprises:
a first number of first transmit antennas arranged in a first direction at a first interval; and
a second number of first receive antennas arranged in the first direction at a second interval,
the second module comprises:
a third number of second transmit antennas arranged in the first direction at the first interval;
a fourth number of second receive antennas arranged in the first direction at the second interval; and
a first transmission processor,
an interval between a receive antenna closest to the second module among the first receive antennas and a receive antenna closest to the first module among the second receive antennas corresponds to the second interval,
the phase value generator is configured to generate a first phase value based on a phase difference between received signals of at least two virtual antennas among a plurality of virtual antennas formed based on received signals of at least some of the first receive antennas and the second receive antennas when the first transmit antennas transmit radio waves based on the first reference signal,
the first transmission processor is configured to shift a phase of the second reference signal supplied to the second transmit antennas subsequent to the first transmit antennas by the first phase value.

2. The antenna device of claim 1, wherein
the first phase value is a positive value.

3. The antenna device of claim 1, wherein
the first phase value is a positive integer multiple of the phase difference.

4. The antenna device of claim 3, further comprising
L modules including the first module and the second module, wherein
L is an integer not less than two,
the L modules each include N transmit antennas arranged in the first direction at the first interval, and M receive antennas arranged in the first direction at the second interval,
when the phase difference is φ, the first phase value as a phase shift amount of the second reference signal supplied to an l-th module among the L modules is 1 or more and N×M×(L−1)×(l−1)×φ or less.

5. The antenna device of claim 1, further comprising
a third module to which a third reference signal is supplied from the reference signal generator, wherein
the third module comprises:
a fifth number of third transmit antennas arranged in the first direction at the first interval;
a sixth number of third receive antennas arranged in the first direction at the second interval; and
a second transmission processor,
an interval between a receive antenna closest to the third module among the second receive antennas and a receive antenna closest to the second module among the third receive antennas corresponds to the second interval,
the phase value generator is further configured to generate a second phase based on the phase difference,
the second phase value is different from the first phase value, and
the second transmission processor shifts a phase of the third reference signal supplied to the third transmit antennas subsequent to the second transmit antennas by the second phase value.

6. The antenna device according to claim 5, further comprising
L modules including the first module, the second module, and the third module, wherein
L is an integer not less than three,
the L modules each include N transmit antennas arranged in the first direction at the first interval, and M receive antennas arranged in the first direction at the second interval, and
when the phase difference is φ, each of the first phase value and the second phase value as a phase shift amount of the reference signal supplied to an l-th module among the L modules is 1 or more and N×M×(L−1)×(l−1)×φ or less.

7. The antenna device of claim 5 wherein
the first phase value is generated based on a phase difference between received signals in at least two virtual antennas formed based on received signals received by at least some of the first receive antennas among the virtual antennas, and
the second phase value is generated based on a phase difference between received signals in at least two virtual antennas formed based on received signals received by at least some of the second receive antennas among the virtual antennas.

8. An antenna device comprising:
a reference signal generator;
a first module to which a first reference signal is supplied from the reference signal generator;
a second module to which a second reference signal is supplied from the reference signal generator;
a reception processor; and
a phase value generator, wherein
the first module comprises:
a first number of first transmit antennas arranged in a first direction at a first interval; and
a second number of first receive antennas arranged in the first direction at a second interval,
the second module comprises:
a third number of second transmit antennas arranged in the first direction at the first interval; and
a fourth number of second receive antennas arranged in the first direction at the second interval,
an interval between a receive antenna closest to the second module among the first receive antennas and a receive antenna closest to the first module among the second receive antennas corresponds to the second interval,
the phase value generator configured to generate a first phase value based on a phase difference between received signals of at least two virtual antennas among a plurality of virtual antennas formed based on received signals of at least some of the first receive antennas and the second receive antennas when the first transmit antennas transmit radio waves based on the first reference signal,
the reception processor configured to shift phases of received signals of the first receive antennas and the second receive antennas by the first phase value when radio waves based on the second reference signal are transmitted from the second transmit antennas subsequent to the first transmit antennas.

9. The antenna device of claim 8, further comprising
a third module to which a third reference signal is supplied from the reference signal generator, wherein
the third module comprises:
a fifth number of third transmit antennas arranged in the first direction at the first interval; and
a sixth number of third receive antennas arranged in the first direction at the second interval,
an interval between a receive antenna closest to the third module among the second receive antennas and a receive antenna closest to the second module among the third receive antennas corresponds to the second interval,
the phase value generator further configured to generate a second phase value different from the first phase value based on the phase difference, and
the reception processor configured to shift phases of received signals of the first receive antennas, the second receive antennas, and the third receive antennas by the second phase value in a case where transmission signals based on the third reference signal are transmitted from the third transmit antennas subsequent to the second transmit antennas.

10. The antenna device of claim 9 wherein
the first phase value is generated based on a phase difference between received signals in at least two virtual antennas formed based on received signals received by at least some of the first receive antennas among the virtual antennas, and
the second phase value is generated based on a phase difference between received signals in at least two virtual antennas formed based on received signals received by at least some of the second receive antennas among the virtual antennas.

11. A control method of controlling an antenna device comprising a reference signal generator, a first module to which a first reference signal is supplied from the reference signal generator, a second module to which a second reference signal is supplied from the reference signal generator, and a phase value generator, wherein
the first module comprises:
a first number of first transmit antennas arranged in a first direction at a first interval; and
a second number of first receive antennas arranged in the first direction at a second interval,
the second module comprises:
a third number of second transmit antennas arranged in the first direction at the first interval;
a fourth number of second receive antennas arranged in the first direction at the second interval; and
a first transmission processor,
an interval between a receive antenna closest to the second module among the first receive antennas and a receive antenna closest to the first module among the second receive antennas corresponds to the second interval,
the control method comprising:
generating, by the phase value generator, a first phase value based on a phase difference between received signals of at least two virtual antennas among a plurality of virtual antennas formed based on received signals of at least some of the first receive antennas and the second receive antennas when the first transmit antennas transmit radio waves based on the first reference signal; and
shifting, by the first transmission processor, a phase of the second reference signal supplied to the second transmit antennas subsequent to the first transmit antennas by the first phase value.

12. A control method of controlling an antenna device including a reference signal generator, a first module to which a first reference signal is supplied from the reference signal generator, a second module to which a second reference signal is supplied from the reference signal generator, a reception processor, and a phase value generator, wherein
the first module comprises:
a first number of first transmit antennas arranged in a first direction at a first interval; and
a second number of first receive antennas arranged in the first direction at a second interval,
the second module comprises:
a third number of second transmit antennas arranged in the first direction at the first interval; and
a fourth number of second receive antennas arranged in the first direction at the second interval,
an interval between a receive antenna closest to the second module among the first receive antennas and a receive antenna closest to the first module among the second receive antennas being the second interval,
the control method comprising:
generating, by the phase value generator, a first phase value based on a phase difference between received signals of at least two virtual antennas among a plurality of virtual antennas formed based on received signals of at least some of the first receive antennas and the second receive antennas when the first transmit antennas transmit radio waves based on the first reference signal; and
shifting, by the reception processor, phases of received signals received by the first receive antennas and the second receive antennas by the first phase value when transmission signals based on the second reference signal are supplied to the second transmit antennas subsequent to the first transmit antennas.
